(19) United States
(12) Patent Application Publication
(10) Pub. No.: US 2015/0244028 A1
(43) Pub. Date: Aug. 27, 2015

(54) NONAQUEOUS SECONDARY CELL, AND FIRE-RETARDANT AGENT AND ADDITIVE FOR NONAQUEOUS SECONDARY CELL

(71) Applicants: SHARP KABUSHIKI KAISHA, Osaka (JP); WAKO PURE CHEMICAL INDUSTRIES, LTD., Osaka (JP)

(72) Inventors: Hisayuki Utsumi, Osaka (JP); Takehito Mitate, Osaka (JP); Naoto Nishimura, Osaka (JP); Takahiro Kiyosu, Saitama (JP); Kuniaki Okamoto, Saitama (JP); Tsutomu Watahiki, Saitama (JP)

(21) Appl. No.: 14/429,708

(22) PCT Filed: Sep. 19, 2013
(86) PCT No.: PCT/JP2013/075338

§ 371 Date: Mar. 19, 2015

(30) Foreign Application Priority Data
Sep. 20, 2012 (JP) 2012-207208
Apr. 3, 2013 (JP) 2013-077816

(51) Int. Cl. H01M 10/0567; H01M 10/0569

(52) U.S. Cl. CPC H01M 10/0567; H01M 10/0569; H01M 2300/0025; H01M 2300/0028

(57) ABSTRACT

A nonaqueous secondary cell comprising a positive electrode, a negative electrode, and a nonaqueous electrolytic solution, wherein the nonaqueous electrolytic solution contains at least a cyclic nitrogen-containing compound represented by the following general formula (1):

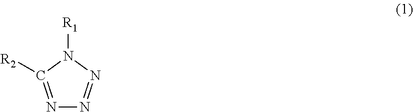

wherein R₁ is selected from a halogen atom, a lower alkyl group, a lower alkenyl group, a lower alkoxy group, a lower alkoxycarbonyl group, a lower alkylcarbonyl group and an aryl group, and R₂ is selected from a hydrogen atom, a halogen atom, a lower alkyl group, a lower alkenyl group, a lower alkoxy group, a lower alkoxycarbonyl group, a lower alkylcarbonyl group and an aryl group; or R₁ and R₂ are bonded together and are selected from a ring structure containing any of a methylene group, a vinylene group and a divalent linking group containing a hetero atom.

### TECHNICAL FIELD

The present invention relates to a nonaqueous secondary cell, and a fire-retardant agent and an additive for the nonaqueous secondary cell. More specifically, the present invention relates to the nonaqueous 10 secondary cell having excellent battery performance and high safety, and the fire-retardant agent and the additive for the nonaqueous secondary cell.

### BACKGROUND ART

In recent years electronic devices have made remarkable progress in reducing in size and weight, and secondary cells used in these electronic devices have been required to enhance their energy density as the progress advances. One of the secondary cells that fulfill the requirement is a secondary cell using a nonaqueous electrolytic solution such as a lithium-ion secondary cell (hereinafter referred to as a nonaqueous secondary cell).

The nonaqueous electrolytic solution comprises an electrolyte salt such as a lithium salt, and a nonaqueous solvent. The nonaqueous solvent is required to have a high-dielectric-constant, a high oxidation potential, and stability in the cell, regardless of an operating environment.

Used as the nonaqueous solvent is an aprotic solvent. Known as the aprotic solvent is, for example, a high-dielectric-constant solvent such as cyclic carbonate esters, e.g., ethylene carbonate and propylene carbonate, and cyclic carboxylic esters, e.g., γ-butyrolactone; and a low-viscosity solvent such as chain-like carbonate esters, e.g., diethyl carbonate and dimethyl carbonate, and ethers, e.g., dimethoxyethane. The high-dielectric-constant solvent and the low-viscosity solvent are usually used in combination.

The nonaqueous electrolytic solution, however, could leak from the nonaqueous secondary cell as a result of an abnormality such as an increase in internal pressure caused by damage to the cell or any other reason. The leaked nonaqueous electrolytic solution could be ignited or catch fire because of a short circuit between a positive electrode and a negative electrode. The heated nonaqueous secondary cell could generate gas because the organic solvent-based nonaqueous solvent is vaporized and/or decomposed. The generated gas causes problems such as igniting and rupturing the nonaqueous secondary cell. To solve these problems, adding a potential blowing agent (e.g., 5-phenyltetrazole in Examples of JP 2006-73308 A) to the nonaqueous electrolytic solution was introduced (see JP 2006-73308 A: Patent Document 1). In Patent Document 1, the potential blowing agent is foamed at a predetermined overcharging potential and raises an internal pressure of the cell so as to properly operate a safety mechanism of the cell.

### PRIOR ART DOCUMENT

### Patent Document

### Patent Document 1: JP 2006-73308 A

### SUMMARY OF THE INVENTION

### Problem that the Invention is to Solve

To meet the growing demand for safety in nonaqueous secondary cells in recent years, even the potential blowing agent of Patent Document 1 became insufficient; and suppressing deterioration in battery performance and improving fire retardancy were required much more.

### Means of Solving the Problem

As a result of intensive studies, the inventors of the present invention found, surprisingly, that a nonaqueous electrolytic solution comprising a cyclic compound containing as many nitrogen atoms as possible in the molecule enables a nonaqueous secondary cell to have sufficient fire retardancy, resulting in the present invention such that the nonaqueous secondary cell is ensured of safety and reliability at a time when the cell heats up abnormally.

The present invention provides a nonaqueous secondary cell comprising a positive electrode, a negative electrode, and a nonaqueous electrolytic solution, wherein the nonaqueous electrolytic solution contains at least a cyclic nitrogen-containing compound represented by the following general formula (1):

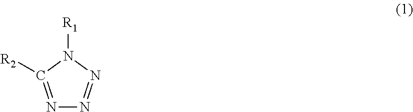

wherein R₁ is selected from a halogen atom, a lower alkyl group, a lower alkenyl group, a lower alkoxy group, a lower alkoxycarbonyl group, a lower alkylcarbonyl group and an aryl group, and R₂ is selected from a hydrogen atom, a halogen atom, a lower alkyl group, a lower alkenyl group, a lower alkoxy group, a lower alkoxycarbonyl group, a lower alkylcarbonyl group and an aryl group; or R₁ and R₂ are bonded together and are selected from a ring structure containing any of a methylene group, a vinylene group and a divalent linking group containing a hetero atom.

The present invention also provides a fire-retardant agent for nonaqueous secondary cell, comprising the cyclic nitrogen-containing compound represented by the general formula (1):

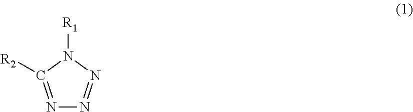

wherein R₁ is selected from a halogen atom, a lower alkyl group, a lower alkenyl group, a lower alkoxy group, a lower alkoxycarbonyl group, a lower alkylcarbonyl group and an aryl group, and R₂ is selected from a hydrogen atom, a halogen atom, a lower alkyl group, a lower alkenyl group, a lower alkoxy group, a lower alkoxycarbonyl group, a lower alkylcarbonyl group and an aryl group; or R₁ and R₂ are bonded together and are selected from a ring structure containing any of a methylene group, a vinylene group and a divalent linking group containing a hetero atom.

The present invention further provides an additive for nonaqueous secondary cell comprising: the above-mentioned fire-retardant agent for nonaqueous secondary cell; and a methylenebissulfonate derivative represented by the following general formula (2):

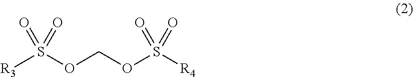

wherein R3 and R₄ are each independently selected from a lower alkyl group, a lower alkenyl group, a lower alkynyl group, a lower alkoxy group, a lower aralkyl group, a heterocyclic group and an aryl group.

### Effect of the Invention

The nonaqueous electrolytic solution of the present invention comprising the cyclic compound having a nitrogen-nitrogen unsaturated bond in the molecule enables the nonaqueous secondary cell to have sufficient fire retardancy. As a result, the nonaqueous secondary cell of the present invention is capable of decreasing a risk of thermal runaway even when abnormalities occur such as an increase in internal temperature of the nonaqueous secondary cell caused by a short circuit, overcharge, or some other reason.

The present invention provides a nonaqueous secondary cell improving in fire retardancy, and more excellent in load characteristics and cycle characteristics because the nonaqueous electrolytic solution forms a dense film on a negative-electrode surface, in the case where a nonaqueous electrolytic solution contains a methylenebissulfonate derivative represented by the following general formula (2):

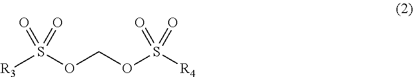

wherein R₃ and R₄ are each independently selected from a lower alkyl group, a lower alkenyl group, a lower alkynyl group, a lower alkoxy group, a lower aralkyl group, a heterocyclic group and an aryl group.

The present invention provides a nonaqueous secondary cell further improving in fire retardancy and excellent in load characteristics and cycle characteristics in the case where R₂ of the cyclic nitrogen-containing compound represented by the general formula (1) is selected from a halogen atom, a lower alkyl group, a lower alkenyl group, a lower alkoxy group, a lower alkoxycarbonyl group, a lower alkylcarbonyl group and an aryl group; or is bonded with R₁ and are selected from a ring structure containing any of a methylene group, a vinylene group and a divalent linking group containing a hetero atom.

The present invention provides a nonaqueous secondary cell further improving in fire retardancy and excellent in load characteristics and cycle characteristics in the case where, in R₁ and R₂ of the cyclic nitrogen-containing compound represented by the general formula (1), the lower alkyl group is an alkyl group having 1 to 6 carbon atoms, the lower alkoxy group is an alkoxy group having 1 to 6 carbon atoms, and the lower alkenyl group is an alkenyl group having 2 to 6 carbon atoms.

The present invention provides a nonaqueous secondary cell further improving in fire retardancy and excellent in load characteristics and cycle characteristics in the case where, in R₁ and R₂ of the cyclic nitrogen-containing compound represented by the general formula (1), R₁ is an alkyl group having 1 to 6 carbon atoms or an aryl group, and R₂ is a hydrogen atom or an alkyl group having 1 to 6 carbon atoms; or R₁ and R₂ are bonded together and are a ring structure containing a methylene group.

The present invention provides a nonaqueous secondary cell further improving in fire retardancy and excellent in load characteristics and cycle characteristics in the case where, in R₃ and R₄ of the general formula (2), the lower alkyl group is an alkyl group having 1 to 6 carbon atoms, the lower alkoxy group is an alkoxy group having 1 to 6 carbon atoms, the lower alkenyl group is an alkenyl group having 2 to 8 carbon atoms, the lower alkynyl group is an alkynyl group having 2 to 8 carbon atoms, the lower aralkyl group is an aralkyl group having 7 to 15 carbon atoms, and the aryl group is an aryl group having 6 to 10 carbon atoms.

The present invention provides a nonaqueous secondary cell further improving in fire retardancy and excellent in load characteristics and cycle characteristics in the case where, in R₃ and R₄ of the methylenebissulfonate derivative represented by the general formula (2), R₃ and R₄ are each an alkyl group having 1 to 6 carbon atoms, an alkenyl group having 2 to 8 carbon atoms or an aryl group.

The present invention provides a nonaqueous secondary cell further improving in fire retardancy and excellent in load characteristics and cycle characteristics in the case where from 1 to 60 vol % of the cyclic nitrogen-containing compound represented by the general formula (1) is contained in the nonaqueous electrolytic solution, and/or from 0.01 to 2 vol % of the methylenebissulfonate derivative represented by the general formula (2) is contained in the nonaqueous electrolytic solution.

The present invention provides a nonaqueous secondary cell further improving in fire retardancy and excellent in load characteristics and cycle characteristics in the case where the nonaqueous electrolytic solution contains diethyl carbonate as an organic solvent.

### MODE FOR CARRYING OUT THE INVENTION

A nonaqueous secondary cell of the present invention comprises a positive electrode, a negative electrode, and a nonaqueous electrolytic solution. More specifically, the present invention is characterized by containing in the nonaqueous electrolytic solution a cyclic nitrogen-containing compound, as a fire-retardant agent, having a structure represented by the following general formula (1). In addition, the nonaqueous electrolytic solution contains the cyclic nitrogen-containing compound and an electrolyte salt.

### (a) Nonaqueous Electrolytic Solution

### (Cyclic Nitrogen-Containing Compound)

The inventors of the present invention conceive that the cyclic nitrogen-containing compound having the structure represented by the general formula (1) has a mechanism exhibiting the following fire retardancy: the cyclic nitrogen-containing compound is decomposed by heat caused by thermal runaway (generation of fire) of the nonaqueous secondary cell, thus a nitrogen (N₂) gas is generated, resulting in a decrease in surrounding oxygen concentration and extinction of fire origin (suffocative extinction). To substantialize such a mechanism, it is necessary for the cyclic nitrogen-containing compound to have as many nitrogen atoms as possible in its ring.

The cyclic nitrogen-containing compound used in the present invention is represented by the general formula (1):

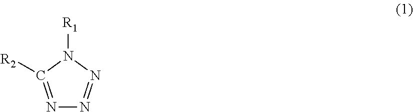

wherein R₁ is selected from a halogen atom, a lower alkyl group, a lower alkenyl group, a lower alkoxy group, a lower alkoxycarbonyl group, a lower alkylcarbonyl group and an aryl group, and R₂ is selected from a hydrogen atom, a halogen atom, a lower alkyl group, a lower alkenyl group, a lower alkoxy group, a lower alkoxycarbonyl group, a lower alkylcarbonyl group and an aryl group; or R₁ and R₂ are bonded together and are selected from a ring structure containing any of a methylene group, a vinylene group and a divalent linking group containing a hetero atom.

In R₁ and R₂, R₂ exemplified above may contain a hydrogen atom; however, R₁ exemplified above does not contain a hydrogen atom. The reason for this that the inventors conceive will be described below.

In the case where the functional group R₁, which binds to the nitrogen atom in the cyclic nitrogen-containing compound represented by the general formula (1), is a hydrogen atom, this hydrogen atom binding to the nitrogen atom could be deprotonated because of lithium ions (cation) in the electrolytic solution. The deprotonated compound of the general formula (1) becomes an anion, resulting in the possibility of complex formation. Because of this complex, it may become certainly possible for the lithium-ion secondary cell to be incapable of fulfilling its original function.

In the above-described exemplification of R₁ and R₂, used as the halogen atom is a fluorine atom, a chlorine atom, a bromine atom, an iodine atom, or the like.

In the above-described exemplification of R₁ and R₂, used as the lower alkyl group is an alkyl group having 1 to 6 carbon atoms such as a methyl group, an ethyl group, a propyl group, a butyl group, a pentyl group or a hexyl group. Used as the lower alkenyl group is an alkenyl group having 2 to 6 carbon atoms such as a vinyl group, a propenyl group, a butenyl group, a pentenyl group or a hexenyl group. Used as the lower alkoxy group is an alkoxy group having 1 to 6 carbon atoms such as a methoxy group, an ethoxy group, a propoxy group, a butoxy group, a pentyloxy group or a hexyloxy group.

In the above-described exemplification of R₁ and R₂, a lower alkoxy group derived from the lower alkoxycarbonyl group binding to a carbonyl group is the same as those exemplified above as the lower alkoxy group; and a lower alkyl group derived from the lower alkylcarbonyl group binding to a carbonyl group is the same as those exemplified above as the lower alkyl group. Specific examples of the lower alkoxycarbonyl group include an alkoxycarbonyl group having 2 to 7 carbon atoms such as a methoxycarbonyl group, an ethoxycarbonyl group, a propoxycarbonyl group, a butoxycarbonyl group, a pentyloxycarbonyl group and a hexyloxycarbonyl group. Specific examples of the lower alkylcarbonyl group include an alkylcarbonyl group having 2 to 7 carbon atoms such as an ethanoyl group, a propanoyl group, a butanoyl group, a pentanoyl group, a hexanoyl group and a heptanoyl group.

Specific examples of the above-described lower alkyl group, lower alkoxy group, lower alkoxycarbonyl group and lower alkylcarbonyl group include linear, branched or cyclic structural isomers. From the viewpoint of improving synthetic easiness and fire retardancy, it is preferable to use the linear groups.

In the above-described exemplification of R₁ and R₂, used as the aryl group is an aryl group having 6 to 10 carbon atoms such as a phenyl group or a naphthyl group.

R₁ and R₂ exemplified above may be the same or different (provided that R₁ should not be a hydrogen atom).

It is preferable that R₁ exemplified above is the lower alkyl group or the aryl group, and it is more preferable that R₁ is the alkyl group having 1 to 3 carbon atoms or the phenyl group.

It is preferable that R₂ exemplified above is the hydrogen atom or the lower alkyl group, and it is more preferable that R₂ is the hydrogen atom or the alkyl group having 1 to 3 carbon atoms.

R₁ and R₂ may be bonded together and may form a ring structure.

The number of atoms forming the ring structure ranges, for example, from 3 to 10 (provided that substituents are not included). This ring structure contains any of the methylene group, the vinylene group and the divalent linking group containing the hetero atom. Used as the divalent linking group containing the hetero atom is, for example, an azo group, an epoxy group, an epithio group or an imino group. From the viewpoint of the synthetic easiness, it is preferable to use a saturated ring structure, i.e., the ring structure containing a methylene group; and among them, it is more preferable to use the ring structure containing a methylene group only and having 5 to 7 atoms.

In the above-described exemplification of R₁ and R₂, the lower alkyl group, the lower alkenyl group, the lower alkoxy group, the lower alkoxycarbonyl group, the lower alkylcarbonyl group, the aryl group, the methylene group, the vinylene group and the ring structure may have a substituent, provided that the groups have a substitution position. Used as the substituent binding to the aryl group is a halogen atom such as a chlorine atom or a fluorine atom, a lower alkyl group having 1 to 4 carbon atoms, or the like. Used as the substituent binding to groups except for the aryl group is a halogen atom such as a chlorine atom or a fluorine atom. The substitution position and the number of the substituents are not particularly limited. The cyclic nitrogen-containing compound may be a mixture of substitution position isomers.

It is preferable that the cyclic nitrogen-containing compound represented by the general formula (1) has the following features: R₁ is the alkyl group having 1 to 6 carbon atoms or the aryl group, and R₂ is the hydrogen atom or the alkyl group having 1 to 6 carbon atoms; or R₁ and R₂ are bonded together and form the ring structure containing the methylene group.

The cyclic nitrogen-containing compound generates a nitrogen gas by the application of heat above a decomposition temperature. It is preferable that the decomposition temperature is higher than an operating environmental temperature of an environment where traditional nonaqueous secondary cells are used. More specifically, the decomposition temperature of 100 to 350° C. is preferable; and the decomposition temperature of 140 to 320° C. is more preferable.

Specific examples of the cyclic nitrogen-containing compound include 5-ethyl-1-methyl-1H-tetrazole, 1-methyl-1H-tetrazole, 1,5-di-n-propyl-1H-tetrazole, 5-methyl-1-phenyl-1H-tetrazole and 6,7,8,9-tetrahydro-5H-tetrazole[1,5-a]azepine.

Used as the cyclic nitrogen-containing compound may be, for example, a commercially available product and may be obtained by carrying out the following reaction scheme:

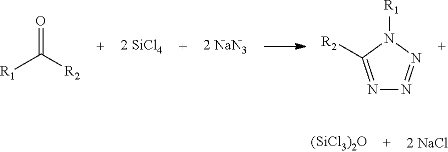

More specifically, the cyclic nitrogen-containing compound may be synthesized by, for example, a method described in El-Ahl, A. A. S., Elmorsy, S. S., Solimman, H., and Amer, F. A. Tetrahedron Lett. 36. 1995: 7337, through either one of the following procedures: ketone having R₁ and R₂, silicon tetrachloride and sodium azide are reacted at room temperature (see the formula 1 on page 7337); and the compound may be synthesized by ketone having R₁ and R₂ bonded together to form a ring structure is used (see the formula 2 on page 7337). The cyclic nitrogen-containing compound may also be synthesized by carrying out the following reaction scheme (see, for example, a method (reaction pathways i and iii of Scheme 2) described in Casey, M., Moody, C. J., and Rees, C. W. J. Chem. Soc. Perkin Trans. 1. 1987: 1389:

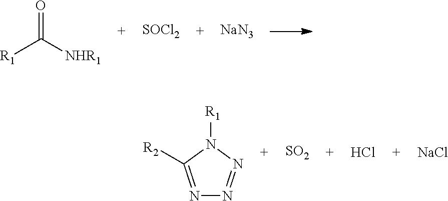

### (Methylenebissulfonate Derivative)

To obtain a nonaqueous secondary cell with high capacity, it is significant to suppress irreversible reactions of a nonaqueous electrolytic solution mainly on a negative-electrode surface at the time of initial charge. To obtain a nonaqueous secondary cell having good cycle characteristics, it is significant that the nonaqueous secondary cell is stable even after being repeatedly charged and discharged and has a dense film formed therein. To form the dense film, it is preferable that the present invention contains in the nonaqueous electrolytic solution a methylenebissulfonate derivative having a structure represented by the following general formula (2). The inventors of the present invention conceive that the methylenebissulfonate derivative having this specific structure is capable of forming a film on a negative-electrode active material, the film does not inhibit de-insertion of lithium ions into the negative-electrode active material, and is capable of playing a role as a film-forming agent.

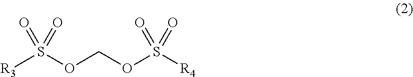

wherein R₃ and R₄ are each independently selected from a lower alkyl group, a lower alkenyl group, a lower alkynyl group, a lower alkoxy group, a lower aralkyl group, a heterocyclic group and an aryl group.

In the above-described exemplification of R₃ and R₄, the lower alkyl group may be linear, branched, or cyclic; and among them, the linear or cyclic lower alkyl group is preferable. Specific examples of the lower alkyl group include an alkyl group having 1 to 6 carbon atoms such as a methyl group, an ethyl group, an n-propyl group, an isopropyl group, an n-butyl group, an isobutyl group, a sec-butyl group, a tert-butyl group, an n-pentyl group, an isopentyl group, a sec-pentyl group, a tert-pentyl group, a neopentyl group, a 1-methylbutyl group, an n-hexyl group, an isohexyl group, a sec-hexyl group, a tert-hexyl group, a neohexyl group, a cyclopropyl group, a cyclobutyl group, a cyclopentyl group, and a cyclohexyl group; and among them, a linear or cyclic alkyl group having 1 to 4 carbon atoms is preferable such as a methyl group, an ethyl group, an n-propyl group, an n-butyl group, a cyclopropyl group or a cyclobutyl group.

The lower alkyl group may have a substituent such as an acyl group, an alkoxy group, a cyano group, a nitro group, an aryloxy group, an acyloxy group or a halogen atom. The substituent may be present at one or more substituent positions of the alkyl group.

As the substituent binding to the lower alkyl group, the acyl group usually has 2 to 6 carbon atoms. Specific examples of the acyl group include an acetyl group, a propionyl group, a butyryl group, an isobutyryl group, a valeryl group, an isovaleryl group, a pivaloyl group and a hexanoyloxy group.

As the substituent binding to the lower alkyl group, the alkoxy group may be linear, branched, or cyclic and usually has 1 to 4 carbon atoms. Specific examples of the alkoxy group include a methoxy group, an ethoxy group, an n-propoxy group, an isopropoxy group, an n-butoxy group, an isobutoxy group, a sec-butoxy group and a tert-butoxy group.

As the substituent binding to the lower alkyl group, the aryloxy group usually has 6 to 10 carbon atoms. Specific examples of the aryloxy group include a phenyloxy group and a naphthyloxy group.

As the substituent binding to the lower alkyl group, the acyloxy group may be linear, branched, or cyclic. The acyloxy group usually is derived from a carboxylic acid having 2 to 6 carbon atoms; and among them, it is preferable that the acyloxy group is derived from a carboxylic acid having 2 or 3 carbon atoms. Specific examples of the acyloxy group include: an acyloxy group derived from an aliphatic saturated carboxylic acid such as an acetyloxy group, a propionyloxy group, a butyryloxy group, an isobutyryloxy group, a valeryloxy group, an isovaleryloxy group, a pivaloyloxy group and a hexanoyloxy group; and an acyloxy group derived from an aliphatic unsaturated carboxylic acid such as an acryloyloxy group, a propioloyloxy group, a methacryloyloxy group, a crotonoyloxy group, an isocrotonoyloxy group, a pentenoyloxy group and a hexenoyloxy group.

As the substituent binding to the lower alkyl group, used as the halogen atom is, for example, a fluorine atom, a chlorine atom, a bromine atom or an iodine atom.

In the above-described exemplification of R₃ and R₄, the lower alkenyl group may be linear, branched, or cyclic. The lower alkenyl group usually has 2 to 8 carbon atoms; and among them, the lower alkenyl group having 2 to 4 carbon atoms is preferable; and further among them, the lower alkenyl group having 2 or 3 carbon atoms is more preferable. Specific examples of the alkenyl group having 2 to 8 carbon atoms include a vinyl group, an allyl group, a 1-propenyl group, an isopropenyl group, a 1-butenyl group, a 2-butenyl group, a 2-methylallyl group, a 1-pentenyl group, a 2-pentenyl group, a 2-methyl-2-butenyl group, a 3-methyl-2-butenyl group, a 1-hexenyl group, a 2-hexenyl group, a 3-hexenyl group, a 2-methyl-2-pentenyl group, a 1-heptenyl group, a 2-heptenyl group, a 3-heptenyl group, a 1-octenyl group, a 2-octenyl group, a 3-octenyl group, a 4-octenyl group, a 1-cyclobutenyl group, a 1-cyclopentenyl group, a 1-cyclohexenyl group, a 1-cycloheptenyl group and a 1-cyclooctenyl group; and among them, the alkenyl group having 2 to 4 carbon atoms is preferable such as a vinyl group, an allyl group, a 1-propenyl group, an isopropenyl group, a 1-butenyl group, a 2-butenyl group or a 2-methylallyl group; and further among them, the alkenyl group having 2 or 3 carbon atoms is more preferable such as a vinyl group or an allyl group.

The lower alkenyl group may have a substituent such as an alkyl group, an aryl group, an acyl group, an alkoxy group, a cyano group, a nitro group, an aryloxy group or an acyloxy group.

As the substituent binding to the lower alkenyl group, the alkyl group has 1 to 6 carbon atoms; and among them, the alkyl group having 1 to 4 carbon atoms is preferable; and further among them, the alkyl group having 1 or 2 carbon atoms is more preferable. Specific examples of the alkyl group are the same as those exemplified above as the lower alkyl group in the above-described exemplification of R₃ and R₄.

As the substituent binding to the lower alkenyl group, the aryl group has 6 to 10 carbon atoms. Specific examples of the aryl group include a phenyl group and a naphthyl group.

As the substituents binding to the lower alkenyl group, specific examples of the acyl group, the alkoxy group, the aryloxy group, and the acyloxy group are respectively the same as those exemplified above as the acyl group, the alkoxy group, the aryloxy group and the acyloxy group in the above-described exemplification of R₃ and R₄.

In the above-described exemplification of R₃ and R₄, the lower alkynyl group may be linear, branched, or cyclic. The lower alkynyl group usually has 2 to 8 carbon atoms; and among them, the lower alkynyl group having 2 to 4 carbon atoms is preferable; and further among them, the lower alkynyl group having 3 carbon atoms is more preferable. Specific examples of the alkynyl group having 2 to 8 carbon atoms include an ethynyl group, a 1-propynyl group, a 2-propynyl group, a 1-butynyl group, a 2-butynyl group, a 1-methyl-2-propynyl group, a 1-pentynyl group, a 2-pentynyl group, a 1-methyl-3-butynyl group, a 1-hexynyl group, a 2-hexynyl group, a 3-hexynyl group, a 2-methyl-4-pentynyl group, a 1-heptynyl group, a 2-heptynyl group, a 3-heptynyl group, a 1-octynyl group, a 2-octynyl group, a 3-octynyl group, and a 4-octynyl group; and among them, the alkynyl group having 2 to 4 carbon atoms is preferable such as an ethynyl group, a 1-propynyl group, a 2-propynyl group, a 1-butynyl group, a 2-butynyl group or a 1-methyl-2-propynyl group; and further among them, the alkynyl group having 3 carbon atoms is more preferable such as a 2-propynyl group.

In the above-described exemplification of R₃ and R₄, the lower alkoxy group may be linear, branched, or cyclic. The lower alkoxy group usually has 1 to 6 carbon atoms; and among them, the lower alkoxy group having 1 to 4 carbon atoms is preferable; and further among them, the lower alkoxy group having 1 or 2 carbon atoms is more preferable. Specific examples of the alkoxy group having 1 to 6 carbon atoms include a methoxy group, an ethoxy group, an n-propoxy group, an isopropoxy group, an n-butoxy group, an isobutoxy group, a sec-butoxy group, a tert-butoxy group, an n-pentyloxy group, an isopentyloxy group, a sec-pentyloxy group, a tert-pentyloxy group, a neopentyloxy group, an n-hexyloxy group, an isohexyloxy group, a sec-hexyloxy group, a tert-hexyloxy group, a neohexyloxy group, a cyclopropoxy group, a cyclobutoxy group, a cyclopentyloxy group and a cyclohexyloxy group; and among them, the alkoxy group having 1 to 4 carbon atoms is preferable such as a methoxy group, an ethoxy group, an n-propoxy group, an isopropoxy group, an n-butoxy group, an isobutoxy group, a sec-butoxy group, a tert-butoxy group, a cyclopropoxy group or a cyclobutoxy group; and further among them, the alkoxy group having 1 or 2 carbon atoms is more preferable such as a methoxy group or an ethoxy group.

In the above-described exemplification of R₃ and R₄, the lower aralkyl group usually has 7 to 15 carbon atoms; and among them, the lower aralkyl group having 7 to 10 carbon atoms is preferable; and further among them, the lower aralkyl group having 7 carbon atoms is more preferable. Specific examples of the aralkyl group having 7 to 15 carbon atoms include a benzyl group, a phenethyl group, a 1-phenylethyl group, a 2-phenylpropyl group, a 3-phenylpropyl group, a phenylbutyl group, a 1-methyl-3-phenylpropyl group and a naphthylmethyl group; and among them, the aralkyl group having 7 to 10 carbon atoms is preferable such as a benzyl group, a phenethyl group, a 1-phenylethyl group, a 2-phenylpropyl group, or a 3-phenylpropyl group; and further among them, the aralkyl group having 7 carbon atoms is more preferable such as a benzyl group.

In the above-described exemplification of R₃ and R₄, the heterocyclic group is, for example, a 5- or 6-membered ring and contains 1 to 3 hetero atoms such as a nitrogen atom, an oxygen atom and a sulfur atom. A specific example of the heterocyclic group is an aliphatic heterocyclic group such as a thienyl group or a pyrrolyl group.

The heterocyclic group may have a substituent. Used as the substituent binding to the heterocyclic group is an alkyl group, an ethylenedioxy group, or the like. The alkyl group may be linear, branched, or cyclic and usually has 1 to 3 carbon atoms. Specific examples of the heterocyclic group include a methyl group, an ethyl group, an n-propyl group and an isopropyl group.

In the above-described exemplification of R₃ and R₄, the aryl group usually has 6 to 14 carbon atoms; and among them, the aryl group having 6 to 10 carbon atoms is preferable. Specific examples of the aryl group having 6 to 14 carbon atoms include a phenyl group, an indenyl group, a naphthyl group, an anthryl group and a phenanthryl group; and among them, the aryl group having 6 to 10 carbon atoms is preferable such as a phenyl group or a naphthyl group.

The aryl group may have a substituent. The number of substituents ranges from one to the number of substitution positions of the aryl group. For example, in the case of the phenyl group, the number of substituents ranges from 1 to 5; and in the case of the naphthyl group, the number of substituents ranges from 1 to 7.

Used as the substituent binding to the aryl group is a halogen atom, an alkyl group having 1 to 6 carbon atoms, a haloalkyl group having 1 to 6 carbon atoms, an alkoxy group having 1 to 6 carbon atoms, an alkenyl group having 2 to 8 carbon atoms, an alkenyloxy group having 2 to 8 carbon atoms, an alkynyl group having 2 to 8 carbon atoms, an alkynyloxy group having 2 to 8 carbon atoms, an alkylsilyl group having 1 to 18 carbon atoms, an alkylsilyloxy group having 1 to 18 carbon atoms, an alkoxycarbonyl group having 2 to 6 carbon atoms, an acyloxy group having 2 to 6 carbon atoms, a phenyl group, a phenyloxy group, a nitro group, or the like.

As the substituent binding to the aryl group, used as the halogen atom is, for example, a fluorine atom, a chlorine atom, a bromine atom or an iodine atom; and among them, the fluorine atom is preferable.

As the substituent binding to the aryl group, the alkyl group having 1 to 6 carbon atoms may be linear, branched, or cyclic; and among them, the linear alkyl group is preferable. The alkyl group usually has 1 to 6 carbon atoms; and among them, the alkyl group having 1 to 4 carbon atoms is preferable; and further among them, the alkyl group having 1 or 2 carbon atoms is more preferable. Specific examples of the alkyl group having 1 to 6 carbon atoms include a methyl group, an ethyl group, an n-propyl group, an isopropyl group, an n-butyl group, an isobutyl group, a sec-butyl group, a tert-butyl group, an n-pentyl group, an isopentyl group, a sec-pentyl group, a tert-pentyl group, a neopentyl group, a 1-methylbutyl group, an n-hexyl group, an isohexyl group, a sec-hexyl group, a tert-hexyl group, a neohexyl group, a cyclopropyl group, a cyclobutyl group, a cyclopentyl group, and a cyclohexyl group; and among them, the alkyl group having 1 to 4 carbon atoms is preferable such as a methyl group, an ethyl group, an n-propyl group, an isopropyl group, an n-butyl group, an isobutyl group, a sec-butyl group, a tert-butyl group, a cyclopropyl group or a cyclobutyl group; and further among them, the alkyl group having 1 or 2 carbon atoms is more preferable such as a methyl group or an ethyl group.

As the substituent binding to the aryl group, the haloalkyl group having 1 to 6 carbon atoms may be linear, branched, or cyclic. The haloalkyl group usually has 1 to 6 carbon atoms; and among them, the haloalkyl group having 1 to 4 carbon atoms is preferable; and further among them, the haloalkyl group having 1 or 2 carbon atoms is more preferable whose one or more hydrogen atoms are substituted by a halogen atom (e.g., a fluorine atom, a chlorine atom, a bromine atom or an iodine atom). Specific examples of the haloalkyl group having 1 to 6 carbon atoms include a fluoromethyl group, a trifluoromethyl group, a 2-fluoroethyl group, a pentafluoroethyl group, a 3-fluoropropyl group, a trifluoropropyl group, a di(trifluoromethyl)methyl group, a heptafluoropropyl group, a 4-fluorobutyl group, a nonafluorobutyl group, a 5-fluoropentyl group, a 2,2,3,3,4,4,5,5-octafluoropentyl group (—CH₂(CF₂)₄H), a perfluoropentyl group, a 6-fluorohexyl group, a perfluorohexyl group, a chloromethyl group, a trichloromethyl group, a 2-chloroethyl group, a pentachloroethyl group, a 3-chloropropyl group, a trichloropropyl group, a di(trichloromethyl)methyl group, a heptachloropropyl group, a 4-chlorobutyl group, a nonachlorobutyl group, a 5-chloropentyl group, a 2,2,3,3,4,4,5,5-octachloropentyl group (—CH₂(CCl₂)₄H), a perchloropentyl group, a 6-chlorohexyl group, a perchlorohexyl group, a bromomethyl group, a tribromomethyl group, a 2-bromoethyl group, a pentabromoethyl group, a 3-bromopropyl group, a tribromopropyl group, a di(tribromomethyl)methyl group, a heptabromopropyl group, a 4-bromobutyl group, a nonabromobutyl group, a 5-bromopentyl group, a 2,2,3,3,4,4,5,5-octabromopentyl group (—CH₂(CBr₂)₄H), a perbromopentyl group, a 6-bromohexyl group, a perbromohexyl group, an iodomethyl group, a triiodomethyl group, a 2-iodoethyl group, a pentaiodoethyl group, a 3-iodopropyl group, a triiodopropyl group, a di(triiodomethyl)methyl group, a heptaiodopropyl group, a 4-iodobutyl group, a nonaiodobutyl group, a 5-iodopentyl group, a 2,2,3,3,4,4,5,5-octaiodopentyl group (—CH₂(Cl₂)₄H), a periodopentyl group, a 6-iodohexyl group, and a periodohexyl group; and among them, the haloalkyl group having 1 to 4 carbon atoms is preferable such as a fluoromethyl group, a trifluoromethyl group, a 2-fluoroethyl group, a pentafluoroethyl group, a 3-fluoropropyl group, a trifluoropropyl group, a di(trifluoromethyl)methyl group, a heptafluoropropyl group, a 4-fluorobutyl group, a nonafluorobutyl group, a chloromethyl group, a trichloromethyl group, a 2-chloroethyl group, a pentachloroethyl group, a 3-chloropropyl group, a trichloropropyl group, a di(trichloromethyl)methyl group, a heptachloropropyl group, a 4-chlorobutyl group, a nonachlorobutyl group, a bromomethyl group, a tribromomethyl group, a 2-bromoethyl group, a pentabromoethyl group, a 3-bromopropyl group, a tribromopropyl group, a di(tribromomethyl)methyl group, a heptabromopropyl group, a 4-bromobutyl group, a nonabromobutyl group, an iodomethyl group, a triiodomethyl group, a 2-iodoethyl group, a pentaiodoethyl group, a 3-iodopropyl group, a triiodopropyl group, a di(triiodomethyl)methyl group, a heptaiodopropyl group, a 4-iodobutyl group, or a nonaiodobutyl; and further among them, the haloalkyl group having 1 or 2 carbon atoms is more preferable such as a fluoromethyl group, a trifluoromethyl group, a 2-fluoroethyl group, a pentafluoroethyl group, a chloromethyl group, a trichloromethyl group, a 2-chloroethyl group, a pentachloroethyl group, a bromomethyl group, a tribromomethyl group, a 2-bromoethyl group, a pentabromoethyl group, an iodomethyl group, a triiodomethyl group, a 2-iodoethyl group or a pentaiodoethyl group.

As the substituent binding to the aryl group, the alkoxy group having 1 to 6 carbon atoms may be linear, branched, or cyclic. The alkoxy group usually has 1 to 6 carbon atoms; and among them, the alkoxy group having 1 to 4 carbon atoms is preferable; and further among them, the alkoxy group having 1 or 2 carbon atoms is more preferable. Specific examples of the alkoxy group having 1 to 6 carbon atoms include a methoxy group, an ethoxy group, an n-propoxy group, an isopropoxy group, an n-butoxy group, an isobutoxy group, a sec-butoxy group, a tert-butoxy group, an n-pentyloxy group, an isopentyloxy group, a sec-pentyloxy group, a tert-pentyloxy group, a neopentyloxy group, an n-hexyloxy group, an isohexyloxy group, a sec-hexyloxy group, a tert-hexyloxy group, a neohexyloxy group, a cyclopropoxy group, a cyclobutoxy group, a cyclopentyloxy group and a cyclohexyloxy group; and among them, the alkoxy group having 1 to 4 carbon atoms is preferable such as a methoxy group, an ethoxy group, an n-propoxy group, an isopropoxy group, an n-butoxy group, an isobutoxy group, a sec-butoxy group, a tert-butoxy group, a cyclopropoxy group or a cyclobutoxy group; and further among them, the alkoxy group having 1 or 2 carbon atoms is more preferable such as a methoxy group or an ethoxy group.

As the substituent binding to the aryl group, the alkenyl group having 2 to 8 carbon atoms may be linear, branched, or cyclic. The alkenyl group usually has 2 to 8 carbon atoms; and among them, the alkenyl group having 2 to 4 carbon atoms is preferable. Specific examples of the alkenyl group having 2 to 8 carbon atoms include a vinyl group, an allyl group, a 1-propenyl group, an isopropenyl group, a 1-butenyl group, a 2-butenyl group, a 2-methylallyl group, a 1-pentenyl group, a 2-pentenyl group, a 2-methyl-2-butenyl group, a 1-hexenyl group, a 2-hexenyl group, a 3-hexenyl group, a 2-methyl-2-pentenyl group, a 1-heptenyl group, a 2-heptenyl group, a 3-heptenyl group, a 1-octenyl group, a 2-octenyl group, a 3-octenyl group, a 4-octenyl group, a 1-cyclobutenyl group, a 1-cyclopentenyl group, a 1-cyclohexenyl group, a 1-cycloheptenyl group, and a 1-cyclooctenyl group; and among them, the alkenyl group having 2 to 4 carbon atoms is preferable such as a vinyl group, an allyl group, a 1-propenyl group, an isopropenyl group, a 1-butenyl group, a 2-butenyl group or a 2-methylallyl group.

As the substituent binding to the aryl group, the alkenyloxy group having 2 to 8 carbon atoms may be linear, branched, or cyclic. The alkenyloxy group usually has 2 to 8 carbon atoms; and among them, the alkenyloxy group having 2 to 4 carbon atoms is preferable. Specific examples of the alkenyloxy group having 2 to 8 carbon atoms include a vinyloxy group, an allyloxy group, a 1-propenyloxy group, an isopropenyloxy group, a 1-butenyloxy group, a 2-butenyloxy group, a 2-methylallyloxy group, a 1-pentenyloxy group, a 2-pentenyloxy group, a 2-methyl-2-butenyloxy group, a 1-hexenyloxy group, a 2-hexenyloxy group, a 3-hexenyloxy group, a 2-methyl-2-pentenyloxy group, a 1-heptenyloxy group, a 2-heptenyloxy group, a 3-heptenyloxy group, a 1-octenyloxy group, a 2-octenyloxy group, a 3-octenyloxy group, a 4-octenyloxy group, a 1-cyclobutenyloxy group, a 1-cyclopentenyloxy group, a 1-cyclohexenyloxy group, a 1-cycloheptenyloxy group, and a 1-cyclooctenyloxy group; and among them, the alkenyloxy group having 2 to 4 carbon atoms is preferable such as a vinyloxy group, an allyloxy group, a 1-propenyloxy group, an isopropenyloxy group, a 1-butenyloxy group, a 2-butenyloxy group or a 2-methylallyloxy group.

As the substituent binding to the aryl group, the alkynyl group having 2 to 8 carbon atoms may be linear, branched, or cyclic. The alkynyl group usually has 2 to 8 carbon atoms; and among them, the alkynyl group having 2 to 4 carbon atoms is preferable. Specific examples of the alkynyl group having 2 to 8 carbon atoms include an ethynyl group, a 1-propynyl group, a 2-propynyl group, a 1-butynyl group, a 2-butynyl group, a 1-methyl-2-propynyl group, a 1-pentynyl group, a 2-pentynyl group, a 1-methyl-3-butynyl group, a 1-hexynyl group, a 2-hexynyl group, a 3-hexynyl group, a 2-methyl-4-pentynyl group, a 1-heptynyl group, a 2-heptynyl group, a 3-heptynyl group, a 1-octynyl group, a 2-octynyl group, a 3-octynyl group, and a 4-octynyl group; and among them, the alkynyl group having 2 to 4 carbon atoms is preferable such as an ethynyl group, a 1-propynyl group, a 2-propynyl group, a 1-butynyl group, a 2-butynyl group or a 1-methyl-2-propynyl group.

As the substituent binding to the aryl group, the alkynyloxy group having 2 to 8 carbon atoms may be linear, branched, or cyclic. The alkynyloxy group usually has 2 to 8 carbon atoms; and among them, the alkynyloxy group having 2 to 4 carbon atoms is preferable. Specific examples of the alkynyloxy group having 2 to 8 carbon atoms include an ethynyloxy group, a 1-propynyloxy group, a 2-propynyloxy group, a 1-butynyloxy group, a 2-butynyloxy group, a 1-methyl-2-propynyloxy group, a 1-pentynyloxy group, a 2-pentynyloxy group, a 1-methyl-3-butynyloxy group, a 1-hexynyloxy group, a 2-hexynyloxy group, a 3-hexynyloxy group, a 2-methyl-4-pentynyloxy group, a 1-heptynyloxy group, a 2-heptynyloxy group, a 3-heptynyloxy group, a 1-octynyloxy group, a 2-octynyloxy group, a 3-octynyloxy group, and a 4-octynyloxy group; and among them, the alkynyloxy group having 2 to 4 carbon atoms is preferable such as an ethynyloxy group, a 1-propynyloxy group, a 2-propynyloxy group, a 1-butynyloxy group, a 2-butynyloxy group or a 1-methyl-2-propynyloxy group.

As the substituent binding to the aryl group, the alkylsilyl group having 1 to 18 carbon atoms may be linear, branched, or cyclic. The alkylsilyl group has a silyl group whose 1 to 3 hydrogen atoms are substituted by an alkyl group usually having 1 to 6 carbon atoms; and among them, it is preferable that the 1 to 3 hydrogen atoms are substituted by an alkyl group having 1 to 4 carbon atoms; and further among them, it is more preferable that the 1 to 3 hydrogen atoms are substituted by an alkyl group having 1 or 2 carbon atoms. Specific examples of the alkylsilyl group whose 1 to 3 hydrogen atoms of the silyl group are substituted by the alkyl group having 1 to 6 carbon atoms include a methylsilyl group, an ethylsilyl group, an n-propylsilyl group, an isopropylsilyl group, an n-butylsilyl group, an isobutylsilyl group, a sec-butylsilyl group, a tert-butylsilyl group, an n-pentylsilyl group, an isopentylsilyl group, a sec-pentylsilyl group, a tert-pentylsilyl group, a neopentylsilyl group, an n-hexylsilyl group, an isohexylsilyl group, a sec-hexylsilyl group, a tert-hexylsilyl group, a neohexylsilyl group, a cyclopropylsilyl group, a cyclobutylsilyl group, a cyclopentylsilyl group, a cyclohexylsilyl group, a dimethylsilyl group, a diethylsilyl group, a di-n-propylsilyl group, a diisopropylsilyl group, a di-n-butylsilyl group, a diisobutylsilyl group, a di-sec-butylsilyl group, a di-tert-butylsilyl group, a di-n-pentylsilyl group, a diisopentylsilyl group, a di-sec-pentylsilyl group, a di-tert-pentylsilyl group, a dineopentylsilyl group, a di-n-hexylsilyl group, a diisohexylsilyl group, a di-sec-hexylsilyl group, a di-tert-hexylsilyl group, a dineohexylsilyl group, a dicyclopropylsilyl group, a dicyclobutylsilyl group, a dicyclopentylsilyl group, a dicyclohexylsilyl group, a trimethylsilyl group, a triethylsilyl group, a tri-n-propylsilyl group, a triisopropylsilyl group, a tri-n-butylsilyl group, a triisobutylsilyl group, a tri-sec-butylsilyl group, a tri-tert-butylsilyl group, a tri-n-pentylsilyl group, a triisopentylsilyl group, a tri-sec-pentylsilyl group, a tri-tert-pentylsilyl group, a trineopentylsilyl group, a tri-n-hexylsilyl group, a triisohexylsilyl group, a tri-sec-hexylsilyl group, a tri-tert-hexylsilyl group, a trineohexylsilyl group, a tricyclopropylsilyl group, a tricyclobutylsilyl group, a tricyclopentylsilyl group, a tricyclohexylsilyl group, a dimethylethylsilyl group, a tert-butyldimethylsilyl group, a dimethylisopropylsilyl group, a diethylisopropylsilyl group, a pentyldimethylsilyl group, and a hexyldimethylsilyl group; and the alkylsilyl group whose 1 to 3 hydrogen atoms of the silyl group are substituted by the alkyl group having 1 to 4 carbon atoms is preferable such as a methylsilyl group, an ethylsilyl group, an n-propylsilyl group, an isopropylsilyl group, an n-butylsilyl group, an isobutylsilyl group, a sec-butylsilyl group, a tert-butylsilyl group, a cyclopropylsilyl group, a cyclobutylsilyl group, a dimethylsilyl group, a diethylsilyl group, a di-n-propylsilyl group, a diisopropylsilyl group, a di-n-butylsilyl group, a diisobutylsilyl group, a di-sec-butylsilyl group, a di-tert-butylsilyl group, a dicyclopropylsilyl group, a dicyclobutylsilyl group, a trimethylsilyl group, a triethylsilyl group, a tri-n-propylsilyl group, a triisopropylsilyl group, a tri-n-butylsilyl group, a triisobutylsilyl group, a tri-sec-butylsilyl group, a tri-tert-butylsilyl group, a tricyclopropylsilyl group, a tricyclobutylsilyl group, a dimethylethylsilyl group, a tert-butyldimethylsilyl group, a dimethylisopropylsilyl group, or a diethylisopropylsilyl group; and further among them, the alkylsilyl group whose 1 to 3 hydrogen atoms of the silyl group are substituted by the alkyl group having 1 or 2 carbon atoms is more preferable such as a methylsilyl group, an ethylsilyl group, a dimethylsilyl group, a diethylsilyl group, a trimethylsilyl group, a triethylsilyl group or a dimethylethylsilyl group.

As the substituent binding to the aryl group, the alkylsilyloxy group having 1 to 18 carbon atoms may be linear, branched, or cyclic. The alkylsilyloxy group has a silyl group whose 1 to 3 hydrogen atoms are substituted by an alkyl group usually having 1 to 6 carbon atoms; and among them, it is preferable that the 1 to 3 hydrogen atoms are substituted by an alkyl group having 1 to 4 carbon atoms; and further among them, it is more preferable that the 1 to 3 hydrogen atoms are substituted by an alkyl group having 1 or 2 carbon atoms. Specific examples of the alkylsilyloxy group whose 1 to 3 hydrogen atoms of the silyl group are substituted by the alkyl group having 1 to 6 carbon atoms include a methylsilyloxy group, an ethylsilyloxy group, an n-propylsilyloxy group, an isopropylsilyloxy group, an n-butylsilyloxy group, an isobutylsilyloxy group, a sec-butylsilyloxy group, a tert-butylsilyloxy group, an n-pentylsilyloxy group, an isopentylsilyloxy group, a sec-pentylsilyloxy group, a tert-pentylsilyloxy group, a neopentylsilyloxy group, an n-hexylsilyloxy group, an isohexylsilyloxy group, a sec-hexylsilyloxy group, a tert-hexylsilyloxy group, a neohexylsilyloxy group, a cyclopropylsilyloxy group, a cyclobutylsilyloxy group, a cyclopentylsilyloxy group, a cyclohexylsilyloxy group, a dimethylsilyloxy group, a diethylsilyloxy group, a di-n-propylsilyloxy group, a diisopropylsilyloxy group, a di-n-butylsilyloxy group, a diisobutylsilyloxy group, a di-sec-butylsilyloxy group, a di-tert-butylsilyloxy group, a di-n-pentylsilyloxy group, a diisopentylsilyloxy group, a di-sec-pentylsilyloxy group, a di-tert-pentylsilyloxy group, a dineopentylsilyloxy group, a di-n-hexylsilyloxy group, a diisohexylsilyloxy group, a di-sec-hexylsilyloxy group, a di-tert-hexylsilyloxy group, a dineohexylsilyloxy group, a dicyclopropylsilyloxy group, a dicyclobutylsilyloxy group, a dicyclopentylsilyloxy group, a dicyclohexylsilyloxy group, a trimethylsilyloxy group, a triethylsilyloxy group, a tri-n-propylsilyloxy group, a triisopropylsilyloxy group, a tri-n-butylsilyloxy group, a triisobutylsilyloxy group, a tri-sec-butylsilyloxy group, a tri-tert-butylsilyloxy group, a tri-n-pentylsilyloxy group, a triisopentylsilyloxy group, a tri-sec-pentylsilyloxy group, a tri-tert-pentylsilyloxy group, a trineopentylsilyloxy group, a tri-n-hexylsilyloxy group, a triisohexylsilyloxy group, a tri-sec-hexylsilyloxy group, a tri-tert-hexylsilyloxy group, a trineohexylsilyloxy group, a tricyclopropylsilyloxy group, a tricyclobutylsilyloxy group, a tricyclopentylsilyloxy group, a tricyclohexylsilyloxy group, a dimethylethylsilyloxy group, a tert-butyldimethylsilyloxy group, a dimethylisopropylsilyloxy group, a diethylisopropylsilyloxy group, a pentyldimethylsilyloxy group and a hexyldimethylsilyloxy group; and among them, the alkylsilyloxy group whose 1 to 3 hydrogen atoms of the silyl group are substituted by the alkyl group having 1 to 4 carbon atoms is preferable such as a methylsilyloxy group, an ethylsilyloxy group, an n-propylsilyloxy group, an isopropylsilyloxy group, an n-butylsilyloxy group, an isobutylsilyloxy group, a sec-butylsilyloxy group, a tert-butylsilyloxy group, a cyclopropylsilyloxy group, a cyclobutylsilyloxy group, a dimethylsilyloxy group, a diethylsilyloxy group, a di-n-propylsilyloxy group, a diisopropylsilyloxy group, a di-n-butylsilyloxy group, a diisobutylsilyloxy group, a di-sec-butylsilyloxy group, a di-tert-butylsilyloxy group, a dicyclopropylsilyloxy group, a dicyclobutylsilyloxy group, a trimethylsilyloxy group, a triethylsilyloxy group, a tri-n-propylsilyloxy group, a triisopropylsilyloxy group, a tri-n-butylsilyloxy group, a triisobutylsilyloxy group, a tri-sec-butylsilyloxy group, a tri-tert-butylsilyloxy group, a tricyclopropylsilyloxy group, a tricyclobutylsilyloxy group, a dimethylethylsilyloxy group, a tert-butyldimethylsilyloxy group, a dimethylisopropylsilyloxy group or a diethylisopropylsilyloxy group; and further among them, the alkylsilyloxy group whose 1 to 3 hydrogen atoms of the silyl group are substituted by the alkyl group having 1 or 2 carbon atoms is more preferable such as a methylsilyloxy group, an ethylsilyloxy group, a dimethylsilyloxy group, a diethylsilyloxy group, a trimethylsilyloxy group, a triethylsilyloxy group or a dimethylethylsilyloxy group.

As the substituent binding to the aryl group, the alkoxycarbonyl group having 2 to 6 carbon atoms may be linear, branched, or cyclic. The alkoxycarbonyl group usually has 2 to 6 carbon atoms; and among them, the alkoxycarbonyl group having 2 to 4 carbon atoms is preferable. Specific examples of the alkoxycarbonyl group having 2 to 6 carbon atoms include a methoxycarbonyl group, an ethoxycarbonyl group, an n-propoxycarbonyl group, an isopropoxycarbonyl group, an n-butoxycarbonyl group, an isobutoxycarbonyl group, a sec-butoxycarbonyl group, a tert-butoxycarbonyl group, an n-pentyloxycarbonyl group, an isopentyloxycarbonyl group, a sec-pentyloxycarbonyl group, a tert-pentyloxycarbonyl group, a neopentyloxycarbonyl group, a cyclopropoxycarbonyl group, a cyclobutoxycarbonyl group, and a cyclopentyloxycarbonyl group; and among them, the alkoxycarbonyl group having 2 to 4 carbon atoms is preferable such as a methoxycarbonyl group, an ethoxycarbonyl group, an n-propoxycarbonyl group, an isopropoxycarbonyl group or a cyclopropoxycarbonyl group.

As the substituent binding to the aryl group, the acyloxy group usually has 2 to 6 carbon atoms; and among them, the acyloxy group having 2 or 3 carbon atoms is preferable. Specific examples of the acyloxy group having 2 to 6 carbon atoms include an acetyloxy group, a propionyloxy group, a butyryloxy group, an isobutyryloxy group, a valeryloxy group, an isovaleryloxy group, a pivaloyloxy group and a hexanoyloxy group; and among them, the acyloxy group having 2 or 3 carbon atoms is preferable such as an acetyloxy group or a propionyloxy group.

Specific examples of the methylenebissulfonate derivative represented by the general formula (2) include methylenebis(methanesulfonate), methylenebis(ethanesulfonate), methylenebis(n-propanesulfonate), methylenebis(n-butanesulfonate), methylenebis(cyclopropanesulfonate), methylenebis(trifluoromethanesulfonate), methylenebis(vinylsulfonate), methylenebis(2-propynylsulfonate), methylenebis(2-cyanoethanesulfonate), methylenebis(methoxysulfonate), methylenebis(ethoxysulfonate), methylenebis(allylsulfonate), methylenebis(2-methylallylsulfonate), methylenebis(3-methyl-2-butenylsulfonate), methylenebis(cinnamylsulfonate), methylenebis(benzylsulfonate), methylenebis(2-thienylsulfonate), methylenebis(4-methyl-2-thienylsulfonate), methylenebis(3,4-ethylenedioxythienylsulfonate) and methylenebis(2-pyrrolylsulfonate) (hereinafter referred to as the group (i)).

Other specific examples of the methylenebissulfonate derivative other than the group (i) above include methylenebis(benzenesulfonate), methylenebis(4-methylbenzenesulfonate), methylenebis(2,4-dimethylbenzenesulfonate), methylenebis(2,4,6-trimethylbenzenesulfonate), methylenebis(4-fluorobenzenesulfonate), methylenebis(2,4-difluorobenzenesulfonate), methylenebis(2,4,6-trifluorobenzenesulfonate), methylenebis(pentafluorobenzenesulfonate), methylenebis(4-chlorobenzenesulfonate), methylenebis(2,5-dichlorobenzenesulfonate), methylenebis(2-trifluoromethylbenzenesulfonate), methylenebis(4-trifluoromethylbenzenesulfonate), methylenebis(2,4-di(trifluoromethyl)benzenesulfonate), methylenebis(2,4,6-tri(trifluoromethyl)benzenesulfonate), methylenebis(4-methoxybenzenesulfonate), methylenebis(4-phenylbenzenesulfonate), methylenebis(4-phenoxybenzenesulfonate), methylenebis(4-vinylbenzenesulfonate), methylenebis(4-trimethylsilylbenzenesulfonate), methylenebis(4-trimethylsilyloxybenzenesulfonate), methylenebis(3-methoxycarbonylbenzenesulfonate), methylenebis(4-acetoxybenzenesulfonate), methylenebis(2,4,5-trichlorobenzenesulfonate), methylenebis(3-nitrobenzenesulfonate), methylenebis(1-naphthalenesulfonate), methylenebis(2-naphthalenesulfonate), methylenebis(2-(4-methoxyl)naphthalenesulfonate) and methylenebis(2-(6-methoxyl)naphthalenesulfonate).

The preferable specific examples of the methylenebissulfonate derivative represented by the general formula (2) include the following compounds No. 1 to 37. Note that the methylenebissulfonate derivatives used in the present invention are not limited to the following compounds 10 in any way.

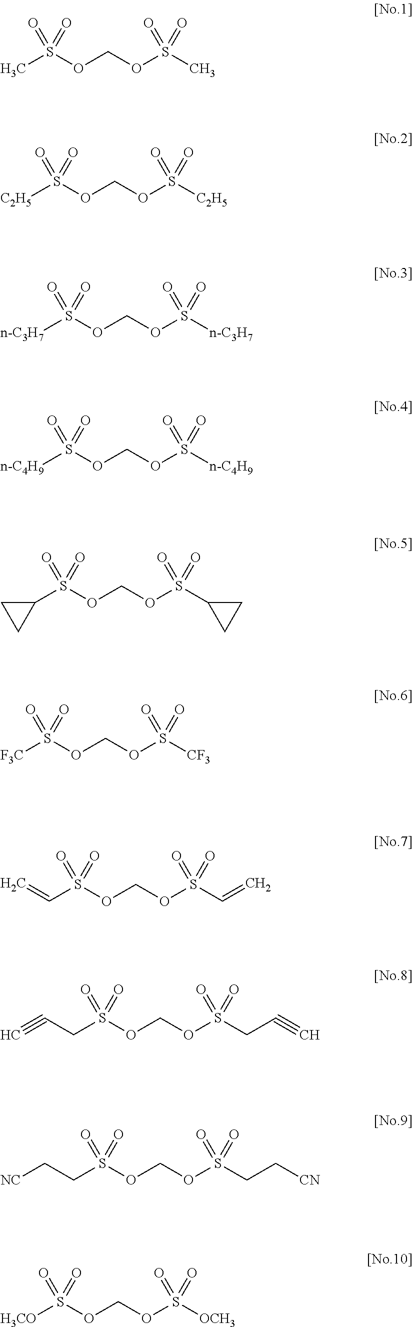

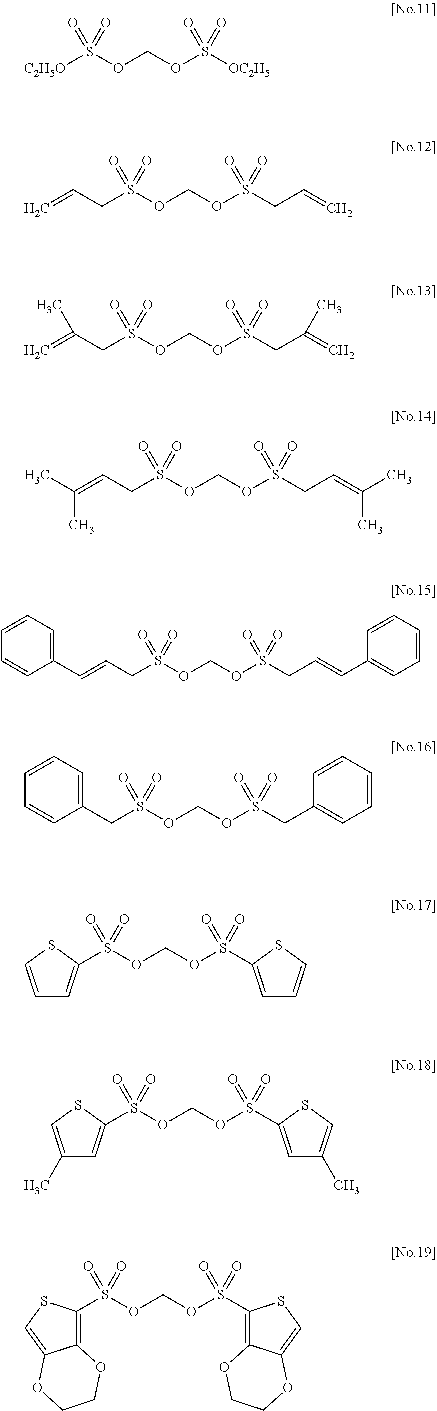

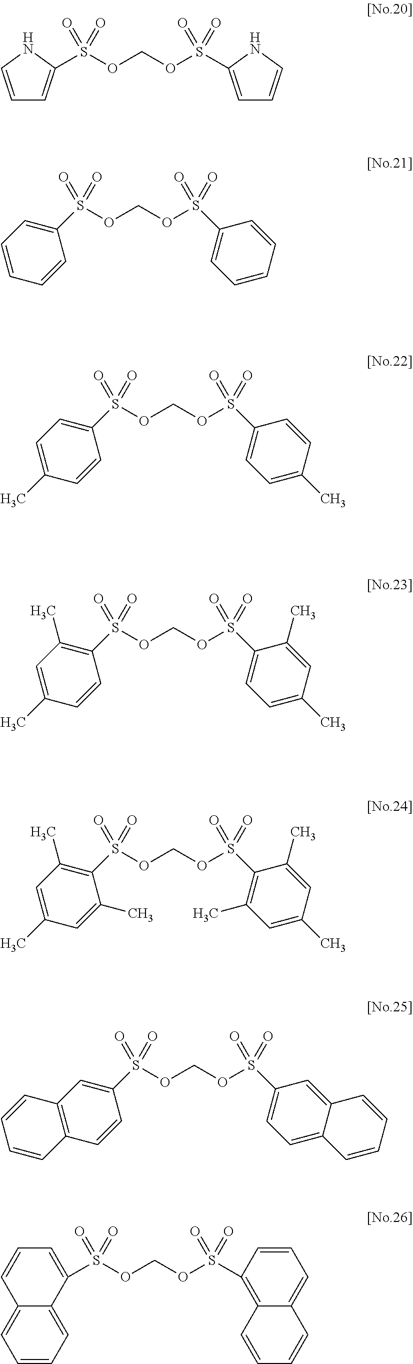

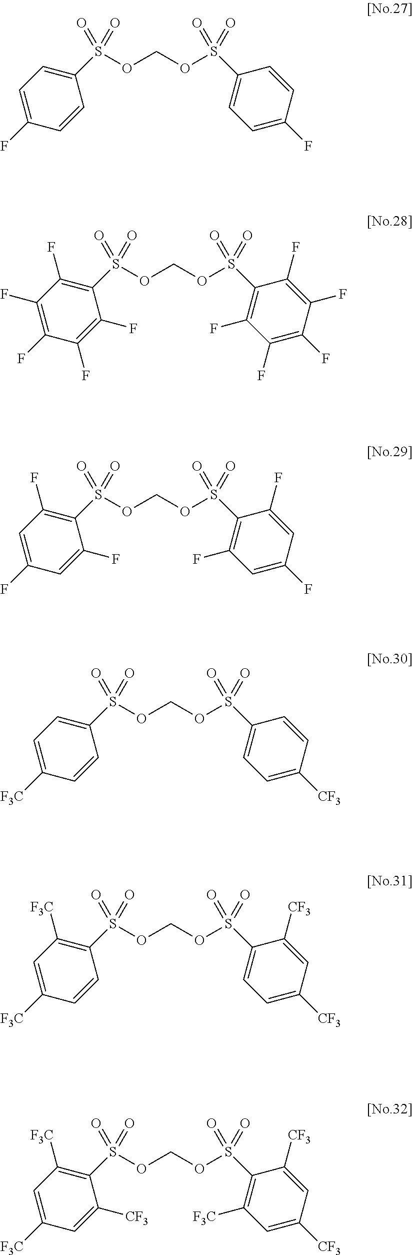

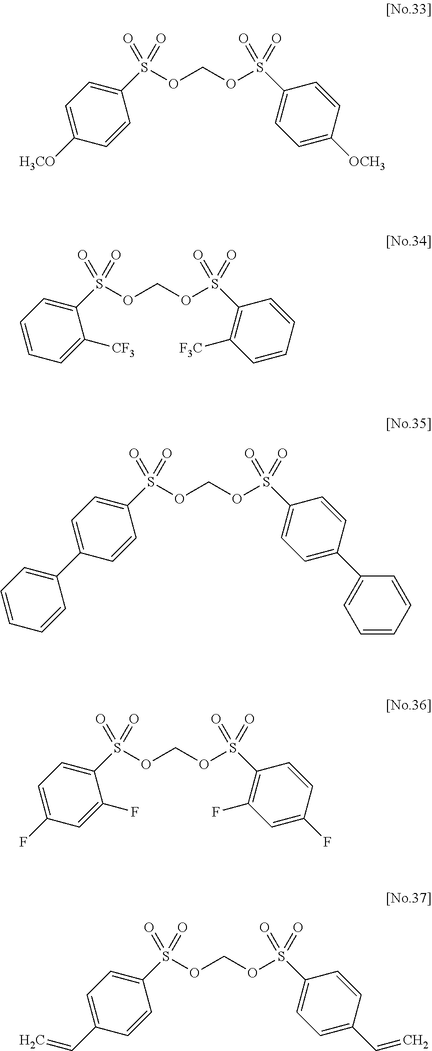

Among the methylenebissulfonate derivatives above, those represented by compounds No. 1 to 4, 7, 8, 12 to 14, 21, 24 to 28, 34 and 35 are more preferable.

Among the above-described methylenebissulfonate derivatives, those are particularly preferable in which R₃ and R₄ are the alkyl group having 1 to 6 carbon atoms, the alkenyl group having 2 to 8 carbon atoms, or the aryl group. These particularly preferable methylenebissulfonate derivatives include compounds No. 1 to 4, 7, 12 to 14 and 21.

At least one of the methylenebissulfonate derivatives represented by the general formula (2) may be used; and two or more of the methylenebissulfonate derivatives may also be used in combination as needed.

The methylenebissulfonate derivative may be synthesized properly according to a conventional method (e.g., International Publication WO 2012/017998 or International Publication WO 2012/017999). More specifically, the methylenebissulfonate derivative may be prepared as follows.

In the following, how to prepare the methylenebissulfonate derivative in which R₃ and R₄ are the same is described, i.e., the methylenebissulfonate derivative represented by the following general formula (2′) as an example.

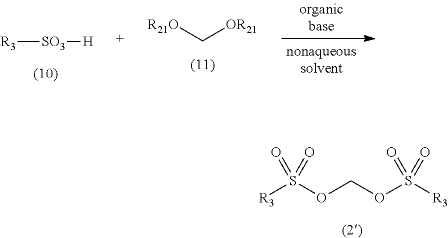

In the general formula (2′), 2 substituents R₂₁ may independently represent: a sulfonyl group represented by —SO₂—R₂₂ wherein R₂₂ represents an alkyl group or an aryl group, each of which may have a halogen atom, a haloalkyl group, an alkoxy group, or a substituent; or an acyl group represented by —COR₂₃ wherein R₂₃ represents an alkyl group or an aryl group, each of which may have a substituent; and 3 substituents R₃ are the same as above.

The methylenebissulfonate derivative represented by the general formula (2) is obtained, for example, by adding a sulfonic acid represented by the general formula (10), from 1 to 4 times mole of an organic base relative to the sulfonic acid, and from 0.2 to 0.5 times mole of a compound represented by the general formula (11) to a suitable nonaqueous solvent and by reacting the mixture while being stirred.

It should be noted that the methylenebissulfonate derivative represented by the general formula (2′) may also be obtained as follows: a sulfonic acid represented by the general formula (10) is mixed with an organic base in a suitable solvent in advance; the mixture may be subjected to condensation, as needed, to remove the solvent; a suitable poor solvent is added, as needed, to the mixture to deposit a salt; the mixture is then filtered so that the salt, which is formed from the sulfonic acid represented by the general formula (10) and the organic base, is isolated; and then the salt is reacted with a compound represented by the general formula (11).

Used as the organic base is the one that enables to form a salt by using the sulfonic acid represented by the general formula (10). Specific examples of the organic base include a secondary amine, a tertiary amine, and a quaternary ammonium salt.

Used as the nonaqueous solvent is aliphatic hydrocarbons, halogenated hydrocarbons, aromatic hydrocarbons, carbonates, esters, ketones, ethers, nitriles, amides, sulfoxides, or the like.

Used as the poor solvent is aliphatic hydrocarbons, halogenated hydrocarbons, aromatic hydrocarbons, carbonates, esters, ketones, ethers, alcohols, nitriles, or the like.

Reaction temperatures are usually from 0 to 150° C., and preferably 20 to 100° C. A reaction time is usually from 0.5 to 24 hours, and preferably 0.5 to 12 hours.

### (Blend Ratio Between a Cyclic Nitrogen-Containing Compound and a Methylenebissulfonate Derivative)

It is desirable that a blend ratio of the cyclic nitrogen-containing compound in the nonaqueous electrolytic solution ranges from 1 to 60 vol % (V/V %). In the case of less than 1 vol % of the cyclic nitrogen-containing compound, the nonaqueous secondary cell may not be sufficiently prevented from being ruptured or ignited. In the case of exceeding 60 vol %, the nonaqueous secondary cell in a low-temperature environment may decrease in performance. The preferable blend ratio ranges from 1 to 40 vol %, and the more preferable blend ratio ranges from 5 to 20 vol %. The blend ratio may also be 7, 9, 11, 13, 15 or 17 vol %.

It is desirable that a blend ratio of the methylenebissulfonate derivative in the nonaqueous electrolytic solution ranges from 0.01 to 2 vol % (V/V %). In the case of less than 0.01 vol % of the methylenebissulfonate derivative, the nonaqueous secondary cell may not sufficiently have an effect of improving charge-discharge characteristics, particularly cycle characteristics. In the case of exceeding 2 vol %, the fully-charged nonaqueous secondary cell at high temperatures of 85° C. or higher may greatly decrease in battery characteristics and may also swell because of gas generated in the cell. The preferable blend ratio ranges from 0.05 to 1 vol %, and the more preferable blend ratio ranges from 0.075 to 0.75 vol %. The blend ratio may also be 0.1, 0.2, 0.3, 0.4, 0.5 or 0.6 vol %.

### (Electrolyte Salt)

Used as an electrolyte salt is usually a lithium salt. The lithium salt is not particularly limited as long as the one is soluble in the nonaqueous solvent contained in the nonaqueous electrolytic solution. Examples of the lithium salt include LiClO₄, LiCl, LiBF₄, LiPF₆, LiAsF₆, LiSbF₆, LiN(SO₂CF₃)₂, LiC(SO₂CF₃)₃, lower aliphatic lithium carboxylate, chloroborane lithium and 4-phenyllithium borate. Among the enumerated lithium salts above, any one of the lithium salts may be used; and two or more of the lithium salts may also be used in combination. It is preferable that an additive amount of the electrolyte salt is from 0.1 to 3 moles with respect to 1 kg of the nonaqueous solvent, and more preferably 0.5 to 2 moles.

### (Other Additives)

The nonaqueous electrolytic solution may contain another additive such as an organic solvent (a nonaqueous solvent), a dehydrating agent, or a deoxidizing agent.

### (i) Organic Solvent

In the case where the cyclic nitrogen-containing compound is in the form of a liquid at an operating temperature of the nonaqueous secondary cell and enables the nonaqueous secondary cell to have sufficient battery characteristics, the cyclic nitrogen-containing compound may be used as an organic solvent; therefore, an additional organic solvent may or may not be used. From the viewpoint of improving charge-discharge characteristics, low-temperature resistance, etc. of the nonaqueous secondary cell, it is desirable that the cyclic nitrogen-containing compound is mixed with the organic solvent and is used as a mixed solvent.

Used as the organic solvent is usually an aprotic organic solvent. The aprotic organic solvent is not particularly limited. Examples of the aprotic organic solvent include a carbonate-based compound (such as dimethyl carbonate, diethyl carbonate, ethylmethyl carbonate, dipropyl carbonate, propylene carbonate, ethylene carbonate, or butylene carbonate), γ-butyrolactone, γ-valerolactone, tetrahydrofuran, 2-methyltetrahydrofuran, dimethyl sulfoxide, 1,3-dioxolane, formamide, dimethylformamide, acetonitrile, methyl formate, methyl acetate, diethyl ether, 1,2-dimethoxyethane, 1,2-diethoxyethane, ethoxymethoxyethane, dioxane, sulfolane and methylsulfolane. Among the enumerated organic solvents above, any one of the organic solvents may be used; and two or more of the organic solvents may also be used in combination.

It is desirable that the organic solvent contains a carbonate-based solvent. It is also desirable that a proportion of the carbonate-based solvent in the organic solvent is from 50 to 80 vol %.

### (ii) Dehydrating Agent and Deoxidizing Agent

Used as a dehydrating agent and a deoxidizing agent are, for example, traditionally known agents. Specific examples of the dehydrating agent and the deoxidizing agent include vinylene carbonate, fluoroethylene carbonate, trifluoropropylene carbonate, phenylethylene carbonate, succinic anhydride, glutaric anhydride, maleic anhydride, ethylene sulfite, 1,3-propane sultone, 1,4-butane sultone, methyl methanesulfonate, dibutyl sulfide, heptane, octane and cycloheptane. The nonaqueous solvent containing the dehydrating agent and the deoxidizing agent in concentrations of 0.1 wt % or more to 5 wt % or less is capable of improving capacity retention characteristics and cycle characteristics even after the nonaqueous secondary cell is stored at high temperatures.

### (b) Positive Electrode

A positive electrode may be prepared by coating a positive-electrode current collector with a paste comprising, for example, a positive-electrode active material, a conductive material, a binder, and an organic solvent, and by drying and pressurizing the paste. Relative to 100 parts by weight of the positive-electrode active material, an amount of the conductive material may be from 1 to 20 parts by weight; an amount of the binder may be from 1 to 15 parts by weight; and an amount of the organic solvent may be from 30 to 60 parts by weight.

Used as the positive-electrode active material is, for example, a lithium composite oxide such as LiNiO₂, LiCoO₂, LiMn₂O₄ or LiFePO₄, or a compound derived from any one of the exemplified oxides above whose element is substituted by another element (e.g., Fe, Si, Mo, Cu or Zn). From the viewpoint of improving load characteristics of the secondary cell, LiFePO₄ may be used as the positive-electrode active material.

Used as the conductive material is, for example, a carbonaceous material such as acetylene black or Ketjen black.

Used as the binder is, for example, polyvinylidene fluoride (PVdF), polyvinyl pyridine, or polytetrafluoroethylene.

Used as the organic solvent is, for example, N-methyl-2-pyrrolidone (NMP) or N,N-dimethylformamide (DMF).

Used as the positive-electrode current collector is, for example, a foil or a sheet made of a conductive metal such as SUS or aluminum.

### (c) Negative Electrode

A negative electrode may be prepared by coating a negative-electrode current collector with a paste comprising, for example, a negative-electrode active material, a conductive material, a binder, and an organic solvent, and by drying and pressurizing the paste. Relative to 100 parts by weight of the negative-electrode active material, an amount of the conductive material may be from 1 to 15 parts by weight; an amount of the binder may be from 1 to 10 parts by weight; and an amount of the organic solvent may be from 40 to 70 parts by weight.

Used as the negative-electrode active material is, for example, pyrolytic carbons, coke, graphite, glassy carbons, organic polymer compound sintered bodies, carbon fibers, or activated carbons.

Used as the conductive material is, for example, a carbonaceous material such as acetylene black or Ketjen black.

Used as the binder is, for example, polyvinylidene fluoride, polyvinyl pyridine, or polytetrafluoroethylene.

Used as the organic solvent is, for example, N-methyl-2-pyrrolidone or N,N-dimethylformamide.

Used as the negative-electrode current collector is, for example, a foil made of a metal such as copper.

### (d) Separator

The negative electrode and the positive electrode may have a separator interposed therebetween.

The separator is usually made of a porous film whose material may be selected in consideration of solvent resistance and reduction resistance. It is desirable that the separator is made of either the porous film or nonwoven fabric, each of which is made of a polyolefin resin such as polyethylene or polypropylene. The separator may be constituted of one layer, or two or more layers, made as above. From the viewpoint of cycle characteristics, low-temperature performance, load characteristics, etc., it is desirable that the multi-layer separator has at least one layer made of the nonwoven fabric.

### (e) Structure of a Nonaqueous Secondary Cell

The nonaqueous secondary cell may be obtained by injecting the nonaqueous electrolytic solution into a gap between the negative electrode and the positive electrode where the separator is optionally interposed. Additionally, a pair of the negative electrode and the positive electrode is considered one unit (or one cell), two or more units may be laminated.

The nonaqueous secondary cell may comprise other materials publicly known and usually used for a nonaqueous secondary cell.

A shape of the nonaqueous secondary cell is not particularly limited; and any one of the following various shapes may be used for the nonaqueous secondary cell: a button type, a coin type, a square type, a cylinder type having a spiral structure, a laminated-type, etc. These shapes may change in size, for example, thin or large, depending on intended use of the nonaqueous secondary cell.

### EXAMPLES

In the following, Examples and Comparative Examples will be described to explain the present invention in detail; however, the present invention is not limited to the following Examples and Comparative Examples in any way.

### Example 1

A cyclic nitrogen-containing compound represented by the following formula (1-1), which is 5-ethyl-1-methyl-1H-tetrazole (manufactured by Wako Pure Chemical Industries, Ltd.) represented by the general formula (1) wherein R₁ is a methyl group, and R₂ is an ethyl group, was added to a mixed solvent (an aprotic organic solvent) of ethylene carbonate (EC) and diethyl carbonate (DEC) (mixing ratio (by volume): ethylene carbonate/diethyl carbonate=1/2) so as to obtain 20 vol % of the cyclic nitrogen-containing compound (and 80 vol % of the mixed solvent).

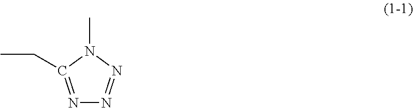

LiPF₆, as a lithium salt, having a concentration of 1.0 mol/kg was dissolved in the obtained mixed solution so as to prepare a nonaqueous electrolytic solution.

100 parts by weight of LiMn₂O₄ as a positive-electrode active material, 5 parts by weight of acetylene black as a conductive material, 7 parts by weight of polyvinylidene fluoride (PVdF) as a binder, and 40 parts by weight of N-methylpyrrolidone (NMP) as a solvent were kneaded using a planetary mixer and dispersed so as to prepare a positive electrode-forming paste. The prepared paste was applied using a coating apparatus to both sides of a strip-shaped aluminum foil, which is a positive-electrode current collector with a thickness of 20 μm, so that the aluminum foil is coated uniformly with the paste. Note that one end of the aluminum foil was not coated so that the uncoated portion is used for terminal connection. The coated foil was dried under reduced pressure at 130° C. for 8 hours so that the solvent is removed, and then the coated foil was pressed using a hydraulic pressing machine to form a positive electrode. The obtained positive electrode was cut into a predetermined size.

100 parts by weight of natural graphite powder (with an average particle diameter of 15 μm) imported from China as a negative-electrode active material, 2 parts by weight of vapor-grown graphite fiber (VGCF) powder (a VGCF high bulk product manufactured by Showa Denko Co.) as a conductive material, 2 parts by weight of PVdF as a binder, and 50 parts by weight of NMP as a solvent were kneaded using a planetary mixer and dispersed so as to prepare a negative electrode-forming paste. The prepared paste was applied using a coating apparatus to both sides of a copper foil, which is a negative-electrode current collector with a thickness of 10 μm, so that the copper foil is coated uniformly with the paste. Note that one end of the copper foil was not coated so that the uncoated portion is used for terminal connection. The coated foil was dried under reduced pressure at 100° C. for 8 hours so that the solvent is removed, and then the coated foil was pressed using a hydraulic pressing machine to form a negative electrode. The obtained negative electrode was cut into a predetermined size.

The obtained positive electrode and negative electrode were laminated with a separator interposed therebetween, which is a porous film made of polypropylene, and then the nonaqueous electrolytic solution was injected into the laminated body, with the result that a nonaqueous secondary cell is prepared.

### Example 2

A nonaqueous secondary cell was prepared in the same manner as Example 1, except that 99 vol % of a mixed solvent of ethylene carbonate and diethyl carbonate (mixing ratio (by volume): ethylene carbonate/diethyl carbonate=1/2) was used; and 1 vol % of a cyclic nitrogen-containing compound represented by the formula (1-1) above was used.

### Example 3

A nonaqueous secondary cell was prepared in the same manner as Example 1, except that 95 vol % of a mixed solvent of ethylene carbonate and diethyl carbonate (mixing ratio (by volume): ethylene carbonate/diethyl carbonate=1/2) was used; and 5 vol % of a cyclic nitrogen-containing compound represented by the formula (1-1) above was used.

### Example 4

A nonaqueous secondary cell was prepared in the same manner as Example 1, except that 40 vol % of a mixed solvent of ethylene carbonate and diethyl carbonate (mixing ratio (by volume): ethylene carbonate/diethyl carbonate=1/2) was used; and 60 vol % of a cyclic nitrogen-containing compound represented by the formula (1-1) above was used.

### Example 5

A nonaqueous secondary cell was prepared in the same manner as Example 1, except that a cyclic nitrogen-containing compound represented by the following formula (1-2), which is 1-methyl-1H-tetrazole (manufactured by Wako Pure Chemical Industries, Ltd.) represented by the general formula (1) wherein R₁ is a methyl group, and R₂ is a hydrogen atom, was added to a mixed solvent of ethylene carbonate and diethyl carbonate (mixing ratio (by volume): ethylene carbonate/diethyl carbonate=1/2) so as to use 5 vol % of the cyclic nitrogen-containing compound (and 95 vol % of the mixed solvent) for the nonaqueous secondary cell.

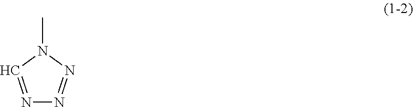

### Example 6

A nonaqueous secondary cell was prepared in the same manner as Example 1, except that a cyclic nitrogen-containing compound represented by the following formula (1-3), which is 1,5-di-n-propyl-1H-tetrazole represented by the general formula (1) wherein R₁ and R₂ are each an n-propyl group, was added to a mixed solvent of ethylene carbonate and diethyl carbonate (mixing ratio (by volume): ethylene carbonate/diethyl carbonate=½) so as to use 5 vol % of the cyclic nitrogen-containing compound (and 95 vol % of the mixed solvent) for the nonaqueous secondary cell.

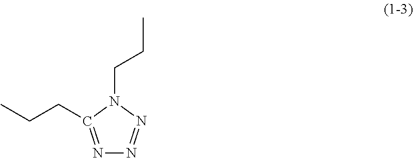

### Example 7

A nonaqueous secondary cell was prepared in the same manner as Example 1, except that a cyclic nitrogen-containing compound represented by the following formula (1-4), which is 5-methyl-1-phenyl-1H-tetrazole represented by the general formula (1) wherein R₁ is a phenyl group, and R₂ is a methyl group, was added to a mixed solvent of ethylene carbonate and diethyl carbonate (mixing ratio (by volume): ethylene carbonate/diethyl carbonate=1/2) so as to use 5 vol % of the cyclic nitrogen-containing compound (and 95 vol % of the mixed solvent) for the nonaqueous secondary cell.

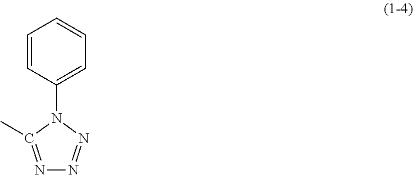

### Example 8

A nonaqueous secondary cell was prepared in the same manner as Example 1, except that a cyclic nitrogen-containing compound represented by the following formula (1-5), which is 6,7,8,9-tetrahydro-5H-tetrazole[1,5-a]azepine (manufactured by Wako Pure Chemical Industries, Ltd.) represented by the general formula (1) wherein R₁ binds to R₂ to form a ring structure having five methylene groups, was added to a mixed solvent of ethylene carbonate and diethyl carbonate (mixing ratio (by volume): ethylene carbonate/diethyl carbonate=1/2) so as to use 5 vol % of the cyclic nitrogen-containing compound (and 95 vol % of the mixed solvent) for the nonaqueous 20 secondary cell.

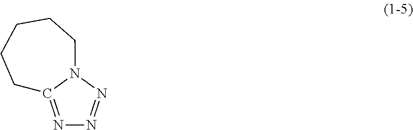

### Comparative Example 1

A nonaqueous secondary cell was prepared in the same manner as Example 1, except that a cyclic nitrogen-containing compound was not used.

### Comparative Example 2

A nonaqueous secondary cell was prepared in the same manner as Example 1, except that a cyclic nitrogen-containing compound represented by the following formula (A), which is 5-phenyl-1H-tetrazole (manufactured by Tokyo Chemical Industry Co., Ltd.) represented by the general formula (1) wherein R₁ is a hydrogen atom, and R₂ is a phenyl group, was added to a mixed solvent of ethylene carbonate and diethyl carbonate (mixing ratio (by volume): ethylene carbonate/diethyl carbonate=1/2) so as to use 0.5 vol % of the cyclic nitrogen-containing compound (and 99.5 vol % of the mixed solvent) for the nonaqueous secondary cell. Note that the compound represented by the formula (A) was poorly soluble in the mixed solvent containing diethyl carbonate and that it was difficult to dissolve 0.5 vol % or more of the compound in the mixed solvent.

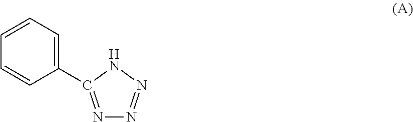 [SMILES: c1ccc(-c2nnn[nH]2)cc1]

### Comparative Example 3

A nonaqueous secondary cell was prepared in the same manner as Example 1, except that a cyclic nitrogen-containing compound represented by the formula (A) above was added to a mixed solvent of ethylene carbonate and ethylmethyl carbonate (EMC) (mixing ratio (by volume): ethylene carbonate/ethylmethyl carbonate=1/1) so as to use 5 vol % of the cyclic nitrogen-containing compound (and 95 vol % of the mixed solvent) for the nonaqueous secondary cell. Note that the compound represented by the formula (A) was poorly soluble in the mixed solvent and that it was difficult to dissolve about 1.0 vol % or more of the compound in the mixed solvent, with the result that the undissolved compound was left as a solid in the mixed solvent.

### Examples 9 to 16 and Comparative Examples 4 to 6

Nonaqueous secondary cells were prepared in the same manner as Examples 1 to 8 and Comparative Examples 1 to 3, except that LiFePO₄ was used as a positive-electrode active material.

### Example 17

A cyclic nitrogen-containing compound represented by the formula (1-1) above and a methylenebissulfonate derivative represented by the following formula (2-1), which is methylenebis(methanesulfonate) (manufactured by Wako Pure Chemical Industries, Ltd.) represented by the general formula (2) wherein R₃ and R₄ are each a methyl group, were added to a mixed solvent (an aprotic organic solvent) of ethylene carbonate (EC) and diethyl carbonate (DEC) (mixing ratio (by volume): ethylene carbonate/diethyl carbonate=1/2) so as to obtain 20 vol % of the cyclic nitrogen-containing compound and 0.1 vol % of the methylenebissulfonate derivative (and 79.9 vol % of the mixed solvent).

A nonaqueous secondary cell was prepared in the same manner as Example 1, except that the mixed solvent obtained above was used.

### Example 18

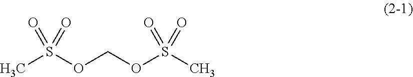

A nonaqueous secondary cell was prepared in the same manner as Example 17, except that 98.9 vol % of a mixed solvent of ethylene carbonate and diethyl carbonate (mixing ratio (by volume): ethylene carbonate/diethyl carbonate=1/2) was used; 1 vol % of a cyclic nitrogen-containing compound represented by the formula (1-1) above was used; and 0.1 vol % of a methylenebissulfonate derivative represented by the formula (2-1) above was used.

### Example 19

A nonaqueous secondary cell was prepared in the same manner as Example 17, except that 94.9 vol % of a mixed solvent of ethylene carbonate and diethyl carbonate (mixing ratio (by volume): ethylene carbonate/diethyl carbonate=½) was used; 5 vol % of a cyclic nitrogen-containing compound represented by the formula (1-1) above was used; and 0.1 vol % of a methylenebissulfonate derivative represented by the formula (2-1) above was used.

### Example 20

A nonaqueous secondary cell was prepared in the same manner as Example 17, except that 40 vol % of a mixed solvent of ethylene carbonate and diethyl carbonate (mixing ratio (by volume): ethylene carbonate/diethyl carbonate=1/2) was used; 59.9 vol % of a cyclic nitrogen-containing compound represented by the formula (1-1) above was used; and 0.1 vol % of a methylenebissulfonate derivative represented by the formula (2-1) above was used.

### Example 21

A nonaqueous secondary cell was prepared in the same manner as Example 17, except that a cyclic nitrogen-containing compound represented by the formula (1-1) above and a methylenebissulfonate derivative represented by the following formula (2-2), which is methylenebis(ethanesulfonate) (manufactured by Wako Pure Chemical Industries, Ltd.) represented by the general formula (2) wherein R₃ and R₄ are each an ethyl group, were added to a mixed solvent of ethylene carbonate and diethyl carbonate (mixing ratio (by volume): ethylene carbonate/diethyl carbonate=1/2) so as to use 5 vol % of the cyclic nitrogen-containing compound and 0.1 vol % of the methylenebissulfonate derivative (and 94.9 vol % of the mixed solvent) for the nonaqueous secondary cell.

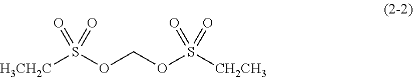

### Example 22

A nonaqueous secondary cell was prepared in the same manner as Example 17, except that a cyclic nitrogen-containing compound represented by the formula (1-1) above and a methylenebissulfonate derivative represented by the following formula (2-3), which is methylenebis(allylsulfonate) (manufactured by Wako Pure Chemical Industries, Ltd.) represented by the general formula (2) wherein R₃ and R₄ are each an allyl group, were added to a mixed solvent of ethylene carbonate and diethyl carbonate (mixing ratio (by volume): ethylene carbonate/diethyl carbonate=1/2) so as to use 5 vol % of the cyclic nitrogen-containing compound and 0.1 vol % of the methylenebissulfonate derivative (and 94.9 vol % of the mixed solvent) for the nonaqueous secondary cell.

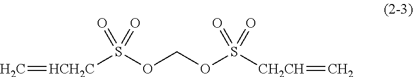

### Example 23

A nonaqueous secondary cell was prepared in the same manner as Example 17, except that a cyclic nitrogen-containing compound represented by the formula (1-2) above and a methylenebissulfonate derivative represented by the formula (2-1) above were added to a mixed solvent of ethylene carbonate and diethyl carbonate (mixing ratio (by volume): ethylene carbonate/diethyl carbonate=1/2) so as to use 5 vol % of the cyclic nitrogen-containing compound and 0.1 vol % of the methylenebissulfonate derivative (and 94.9 vol % of the mixed solvent) for the nonaqueous secondary cell.

### Example 24

A nonaqueous secondary cell was prepared in the same manner as Example 17, except that a cyclic nitrogen-containing compound represented by the formula (1-3) above and a methylenebissulfonate derivative represented by the formula (2-1) above were added to a mixed solvent of ethylene carbonate and diethyl carbonate (mixing ratio (by volume): ethylene carbonate/diethyl carbonate=½) so as to use 5 vol % of the cyclic nitrogen-containing compound and 0.1 vol % of the methylenebissulfonate derivative (and 94.9 vol % of the mixed solvent) for the nonaqueous secondary cell.

### Example 25

A nonaqueous secondary cell was prepared in the same manner as Example 17, except that a cyclic nitrogen-containing compound represented by the formula (1-4) above and a methylenebissulfonate derivative represented by the formula (2-1) above were added to a mixed solvent of ethylene carbonate and diethyl carbonate (mixing ratio (by volume): ethylene carbonate/diethyl carbonate=1/2) so as to use 5 vol % of the cyclic nitrogen-containing compound and 0.1 vol % of the methylenebissulfonate derivative (and 94.9 vol % of the mixed solvent) for the nonaqueous secondary cell.

### Example 26

A nonaqueous secondary cell was prepared in the same manner as Example 17, except that a cyclic nitrogen-containing compound represented by the formula (1-5) above and a methylenebissulfonate derivative represented by the formula (2-1) above were added to a mixed solvent of ethylene carbonate and diethyl carbonate (mixing ratio (by volume): ethylene carbonate/diethyl carbonate=1/2) so as to use 5 vol % of the cyclic nitrogen-containing compound and 0.1 vol % of the methylenebissulfonate derivative (and 94.9 vol % of the mixed solvent) for the nonaqueous secondary cell.

### Comparative Example 7

A nonaqueous secondary cell was prepared in the same manner as Example 17, except that a cyclic nitrogen-containing compound and a methylenebissulfonate derivative were not used.

### Comparative Example 8

A nonaqueous secondary cell was prepared in the same manner as Example 17, except that a cyclic nitrogen-containing compound was not used. (99.9 vol % of a mixed solvent was, however, used.)

### Comparative Example 9

A nonaqueous secondary cell was prepared in the same manner as Example 17, except that a cyclic nitrogen-containing compound represented by the formula (A) above was added, a methylenebissulfonate derivative was not, however, added, to a mixed solvent of ethylene carbonate and diethyl carbonate (mixing ratio (by volume): ethylene carbonate/diethyl carbonate=1/2) so as to use 0.5 vol % of the cyclic nitrogen-containing compound (and 99.5 vol % of the mixed solvent) for the nonaqueous secondary cell. Note that the compound represented by the formula (A) was poorly soluble in the mixed solvent containing diethyl carbonate and that it was difficult to dissolve 0.5 vol % or more of the compound in the mixed solvent.

### Comparative Example 10

A nonaqueous secondary cell was prepared in the same manner as Example 17, except that a cyclic nitrogen-containing compound represented by the formula (A) above was added, a methylenebissulfonate derivative was not, however, added, to a mixed solvent of ethylene carbonate and ethylmethyl carbonate (EMC) (mixing ratio (by volume): ethylene carbonate/ethylmethyl carbonate=1/1) so as to use 5 vol % of the cyclic nitrogen-containing compound (and 95 vol % of the mixed solvent) for the nonaqueous secondary cell. Note that the compound represented by the formula (A) was poorly soluble in the mixed solvent and that it was difficult to dissolve about 1.0 vol % or more of the compound in the mixed solvent, with the result that the undissolved compound was left as a solid in the mixed solvent.

### Examples 27 to 36 and Comparative Examples 11 to 14

Nonaqueous secondary cells were prepared in the same manner as Examples 17 to 26 and Comparative Examples 7 to 10, except that LiFePO₄ was used as a positive-electrode active material.

### (Test Method for Battery Performance)

The nonaqueous secondary cells obtained from Examples 1 to 36 and Comparative Examples 1 to 14 were subjected to the following battery performance tests: measuring initial discharge capacities at 20° C. and 60° C.; measuring discharge capacity retention rates; measuring, as high-temperature storage characteristics, discharge capacity retention rates and recovery rates after the cells were stored at 60° C. for 20 days (480 hours); carrying out a nail penetration test as a safety test; and measuring an electrolyte decomposition temperature using DSC, so as to evaluate load characteristics as follows.

### (1) Measurement of Initial Discharge Capacities at 20° C.

The nonaqueous secondary cells were charged at a 0.1 CmA rate until reaching to a predetermined charging potential and were then discharged at a 0.1 CmA rate, and capacities of the cells measured from the time of the discharge until a voltage reached to a predetermined discharging potential were considered as initial discharge capacities (mAh/g). Note that the cells were each measured at 20° C. in an incubator.

To measure the cells using LiMn₂O₄ as the positive-electrode active material, a predetermined charging potential was set at 4.2 V; and a predetermined discharging potential was set at 3.0 V (Examples 1 to 8 and 17 to 26 and Comparative Examples 1 to 3 and 7 to 10). To measure the cells using LiFePO₄ as the positive-electrode active material, a predetermined charging potential was set at 3.8 V; and a predetermined discharging potential was set at 2.0 V (Examples 9 to 16 and 27 to 36 and Comparative Examples 4 to 6 and 11 to 14).

### (2) Measurement of Discharge Capacity Retention Rates at 20° C.

The nonaqueous secondary cells were subjected to a charge and discharge cycle 99 times, one cycle is considered to start from the time of charging the cells at a 1 CmA rate and reaching to a predetermined charging potential and to end at the time of discharging the cells at a 1 CmA rate and reaching to a predetermined discharging potential, and the 100th cycle was measured to obtain capacities of the cells, provided that charge and discharge conditions were the same as those at the time of measuring the initial discharge capacities.

After completion of the measurement of the 100th cycle, the nonaqueous secondary cells were subjected to another charge and discharge cycle 399 times, this cycle is considered to start from the time of charging the cells at a 1 CmA rate and reaching to a predetermined charging potential and to end at the time of discharging the cells at a 1 CmA rate and reaching to a predetermined discharging potential, and the 500th cycle was measured to obtain capacities of the cells, provided that charge and discharge conditions were the same as those at the time of measuring the initial discharge capacities.

Discharge capacity retention rates (%) in the 100th cycle and the 500th cycle were considered as rates of discharge capacities in the 100th cycle and the 500th cycle, respectively, with respect to the initial discharge capacities. Note that the cells were each measured at 20° C. in an incubator.

To measure the cells using LiMn₂O₄ as the positive-electrode active material, a predetermined charging potential was set at 4.2 V; and a predetermined discharging potential was set at 3.0 V (Examples 1 to 8 and 17 to 26 and Comparative Examples 1 to 3 and 7 to 10). To measure the cells using LiFePO₄ as the positive-electrode active material, a predetermined charging potential was set at 3.8 V; and a predetermined discharging potential was set at 2.0 V (Examples 9 to 16 and 27 to 36 and Comparative Examples 4 to 6 and 11 to 14).

### (3) Measurements of Initial Discharge Capacities and Discharge Capacity Retention Rates at 60° C.

The initial discharge capacities (mAh/g) and the discharge capacity retention rates (%) at 60° C. were measured in the same manner as the initial discharge capacities and the discharge capacity retention rates at 20° C., except that the cells were each measured at 60° C. in an incubator.

### (4) Nail Penetration Test

The nonaqueous secondary cells charged at a 0.1 CmA rate until reaching to a predetermined charging potential were subjected to a nail penetration test at room temperature (20° C.) so as to observe a state of the cells after a nail with a diameter of 3 mm penetrated through the cells at a speed of 1 mm/s. Note that in the case where no abnormality occurred (e.g., smoke or fire), it was considered as “no abnormality (NA).”

To measure the cells using LiMn₂O₄ as the positive-electrode active material, a predetermined charging potential was set at 4.2 V (Examples 1 to 8 and 17 to 26 and Comparative Examples 1 to 3 and 7 to 10). To measure the cells using LiFePO₄ as the positive-electrode active material, a predetermined charging potential was set at 3.8 V (Examples 9 to 16 and 27 to 36 and Comparative Examples 4 to 6 and 11 to 14).

### (5) Measurement of a Decomposition Temperature of an Electrolytic Solution Using DSC

A decomposition temperature (an exothermic onset temperature) of an electrolytic solution was measured as follows using a differential scanning calorimeter: 5 mg of an electrolytic solution containing a cyclic nitrogen-containing compound (a fire-retardant agent) represented by the formula (1-1) to (1-5) or (A) was placed in an SUS airtight container and was heated to 100° C. to 350° C. at a rate of 10° C./min.

Note that the decomposition temperature (the exothermic onset temperature) was considered as a temperature measured at a point where a slope of a DSC curve {vertical axis: heat flow (mW); and horizontal axis: temperature (° C.)} rose to or reached to +0.1 mW/° C.

The electrolyte decomposition temperature of the electrolytic solution was measured for the following reason.

It was known that in case a cell was overly heated, an electrolytic solution was decomposed while generating heat. For instance, in case the electrolytic solution was decomposed while abnormally generating heat because of, for example, a short circuit between a positive electrode and a negative electrode, an increase in temperature of the electrolytic solution accelerated, resulting in a higher risk of rupturing the cell or igniting the electrolytic solution. An electrolytic solution, however, that generates heat at higher temperatures (higher decomposition temperatures) became capable of decreasing the above-described risk.

### (6) Evaluations of Load Characteristics of the Cells

The nonaqueous secondary cells were charged at a 0.1 CmA rate until reaching to 3.8 V and were then discharged at a 0.1 CmA rate, and capacities of these cells from the time of the discharge until a voltage reached to 2.0 V were considered as initial discharge capacities (mAh/g).

The cells were subjected to a charge and discharge test at a 0.1 CmA rate, a 0.3 CmA rate, a 0.5 CmA rate, a 1 CmA rate, and a 3 CmA rate so as to measure a discharge capacity at each rate. As indicated in the following equations, the discharge capacity was divided by the initial discharge capacity to obtain a discharge capacity ratio; and load characteristics of the cells were evaluated. Note that a higher percentage of the discharge capacity ratio means the better load characteristics.

0.1 C=the discharge capacity at the 0.1 CmA rate/the initial discharge capacity×100

0.3 C=the discharge capacity at the 0.3 CmA rate/the initial discharge capacity×100

0.5 C=the discharge capacity at the 0.5 CmA rate/the initial discharge capacity×100

1.0 C=the discharge capacity at the 1.0 CmA rate/the initial discharge capacity×100

3.0 C=the discharge capacity at the 3.0 CmA rate/the initial discharge capacity×100

The test results will be shown in Tables 1 to 8. In these Tables, “fire-retardant agent” indicates a cyclic nitrogen-containing compound; and “film-forming agent” indicates a methylenebissulfonate derivative.

TABLE 1

| | | | example | | | | | | | | comparative example | | |
|---|---|---|---|---|---|---|---|---|---|---|---|---|---|
| | | | 1 | 2 | 3 | 4 | 5 | 6 | 7 | 8 | 1 | 2 | 3 |
| NES | electrolyte | Type | LiPF₆ | LiPF₆ | LiPF₆ | LiPF₆ | LiPF₆ | LiPF₆ | LiPF₆ | LiPF₆ | LiPF₆ | LiPF₆ | LiPF₆ |
| | salt | | | | | | | | | | | | |
| | nonaqueous | type | EC/ | EC/ | EC/ | EC/ | EC/ | EC/ | EC/ | EC/ | EC/ | EC/ | EC/ |
| | solvent | (volume ratio) | DEC | DEC | DEC | DEC | DEC | DEC | DEC | DEC | DEC | DEC | EMC |
| | | | (1/2) | (1/2) | (1/2) | (1/2) | (1/2) | (1/2) | (1/2) | (1/2) | (1/2) | (1/2) | (1/1) |
| | | mixing ratio | 80 | 99 | 95 | 40 | 95 | 95 | 95 | 95 | 100 | 99.5 | 95 |
| | | (v/v %) | | | | | | | | | | | |
| | fire- | Type | 1-1 | 1-1 | 1-1 | 1-1 | 1-2 | 1-3 | 1-4 | 1-5 | — | A | A |
| | retardant | mixing ratio | 20 | 1 | 5 | 60 | 5 | 5 | 5 | 5 | — | 0.5 | 5 |
| | agent | (v/v %) | | | | | | | | | | | |
| EC | initial | discharge capacity | 117.9 | 119 | 118.9 | 114.6 | 118.2 | 120.1 | 119.2 | 118.5 | 115.3 | 2 | 1 |
| (20° | | (mAh/g) | | | | | | | | | | | |
| C.) | 100 cycle | discharge capacity | 114.3 | 116.6 | 115.3 | 110.1 | 113.5 | 118.9 | 118.1 | 113.8 | 106.1 | — | — |
| | | (mAh/g) | | | | | | | | | | | |
| | | DCRR(%) | 97 | 98 | 97 | 96 | 96 | 99 | 99 | 96 | 92 | — | — |
| | 500 cycle | discharge capacity | 107.3 | 109.4 | 108.2 | 103.1 | 106.4 | 110.5 | 109.7 | 106.7 | 94.1 | — | — |
| | | (mAh/g) | | | | | | | | | | | |
| | | DCRR (%) | 91 | 92 | 91 | 90 | 90 | 92 | 92 | 90 | 82 | — | — |
| EC | initial | discharge capacity | 117.1 | 117.8 | 117.5 | 115.7 | 117.1 | 118.9 | 118.4 | 117.6 | 112.6 | 1.4 | 0.8 |
| (60° | | (mAh/g) | | | | | | | | | | | |
| C.) | 100 cycle | discharge capacity | 105.4 | 108.4 | 106.9 | 100.6 | 104.2 | 109.4 | 107.7 | 105.8 | 89.0 | — | — |
| | | (mAh/g) | | | | | | | | | | | |
| | | DCRR(%) | 90 | 92 | 91 | 87 | 89 | 92 | 91 | 90 | 79 | — | — |
| | 500 cycle | discharge capacity | 93.7 | 96.6 | 95.2 | 87.9 | 93.7 | 99.9 | 98.3 | 95.3 | 68.0 | — | — |
| | | (mAh/g) | | | | | | | | | | | |
| | | DCRR (%) | 80 | 82 | 81 | 76 | 80 | 84 | 83 | 81 | 61 | — | — |

| | | | | | | | | | | | |
|---|---|---|---|---|---|---|---|---|---|---|---|
| DT(° C.) | — | — | 271 | — | 267 | 269 | 273 | 276 | 252 | 250 | 261 |
| nail penetration test | NA | NA | NA | NA | NA | NA | NA | NA | smoke/fire | smoke/fire | smoke/fire |

NES = nonaqueous electrolytic solution
EC = electrical characteristic
DT = decomposition temperature of an electrolytic solution using DSC
DCRR = discharge capacity retention rate

TABLE 2

| | | | example | | | | | | | | comparative example | | |
|---|---|---|---|---|---|---|---|---|---|---|---|---|---|
| | | | 9 | 10 | 11 | 12 | 13 | 14 | 15 | 16 | 4 | 5 | 6 |
| NES | electrolyte | Type | LiPF₆ | LiPF₆ | LiPF₆ | LiPF₆ | LiPF₆ | LiPF₆ | LiPF₆ | LiPF₆ | LiPF₆ | LiPF₆ | LiPF₆ |
| | salt | | | | | | | | | | | | |
| | nonaqueous | type | EC/ | EC/ | EC/ | EC/ | EC/ | EC/ | EC/ | EC/ | EC/ | EC/ | EC/ |
| | solvent | (volume ratio) | DEC | DEC | DEC | DEC | DEC | DEC | DEC | DEC | DEC | DEC | EMC |
| | | | (1/2) | (1/2) | (1/2) | (1/2) | (1/2) | (1/2) | (1/2) | (1/2) | (1/2) | (1/2) | (1/1) |
| | | mixing ratio | 80 | 99 | 95 | 40 | 95 | 95 | 95 | 95 | 100 | 99.5 | 95 |
| | | (v/v %) | | | | | | | | | | | |
| | fire- | Type | 1-1 | 1-1 | 1-1 | 1-1 | 1-2 | 1-3 | 1-4 | 1-5 | — | A | A |
| | retardant | mixing ratio | 20 | 1 | 5 | 60 | 5 | 5 | 5 | 5 | — | 0.5 | 5 |
| | agent | (v/v %) | | | | | | | | | | | |
| EC | initial | discharge capacity | 142.6 | 143.7 | 143.4 | 141.7 | 142.7 | 144.5 | 144.1 | 143.1 | 140.4 | 2 | 1 |
| (20° | | (mAh/g) | | | | | | | | | | | |
| C.) | 100 cycle | discharge capacity | 136.9 | 139.4 | 139.1 | 134.6 | 137.0 | 143.1 | 141.2 | 137.4 | 129.2 | — | — |
| | | (mAh/g) | | | | | | | | | | | |
| | | DCRR(%) | 96 | 97 | 97 | 95 | 96 | 99 | 98 | 96 | 92 | — | — |
| | 500 cycle | discharge capacity | 126.9 | 130.8 | 129.1 | 121.9 | 128.4 | 132.9 | 131.1 | 128.8 | 115.1 | — | — |
| | | (mAh/g) | | | | | | | | | | | |
| | | DCRR (%) | 89 | 91 | 90 | 86 | 90 | 92 | 91 | 90 | 82 | — | — |
| EC | initial | discharge capacity | 140.2 | 142.1 | 141.8 | 140.1 | 140.6 | 143.2 | 142.7 | 141.4 | 137.2 | 1.4 | 0.8 |
| (60° | | (mAh/g) | | | | | | | | | | | |
| C.) | 100 cycle | discharge capacity | 124.8 | 130.7 | 129.0 | 121.9 | 125.1 | 131.7 | 129.9 | 127.3 | 107.0 | — | — |
| | | (mAh/g) | | | | | | | | | | | |
| | | DCRR(%) | 89 | 92 | 91 | 87 | 89 | 92 | 91 | 90 | 78 | — | — |
| | 500 cycle | discharge capacity | 106.6 | 116.5 | 114.9 | 102.3 | 111.1 | 123.2 | 119.9 | 113.1 | 83.7 | — | — |
| | | (mAh/g) | | | | | | | | | | | |
| | | DCRR (%) | 76 | 82 | 81 | 73 | 79 | 86 | 84 | 80 | 61 | — | — |

| | | | | | | | | | | | |
|---|---|---|---|---|---|---|---|---|---|---|---|
| DT(° C.) | — | — | 271 | — | 267 | 269 | 273 | 276 | 252 | 250 | 261 |
| nail penetration test | NA | NA | NA | NA | NA | NA | NA | NA | smoke/fire | smoke/fire | smoke/fire |

TABLE 3

| | | | example | | | | | | | | comparative example | | |
|---|---|---|---|---|---|---|---|---|---|---|---|---|---|
| | | | 9 | 10 | 11 | 12 | 13 | 14 | 15 | 16 | 4 | 5 | 6 |
| NES | electrolyte | type | LiPF₆ | LiPF₆ | LiPF₆ | LiPF₆ | LiPF₆ | LiPF₆ | LiPF₆ | LiPF₆ | LiPF₆ | LiPF₆ | LiPF₆ |
| | salt | | | | | | | | | | | | |
| | nonaqueous | type | EC/ | EC/ | EC/ | EC/ | EC/ | EC/ | EC/ | EC/ | EC/ | EC/ | EC/ |
| | solvent | (volume ratio) | DEC | DEC | DEC | DEC | DEC | DEC | DEC | DEC | DEC | DEC | EMC |
| | | | (1/2) | (1/2) | (1/2) | (1/2) | (1/2) | (1/2) | (1/2) | (1/2) | (1/2) | (1/2) | (1/1) |
| | | mixing ratio | 80 | 99 | 95 | 40 | 95 | 95 | 95 | 95 | 100 | 99.5 | 95 |
| | | (v/v %) | | | | | | | | | | | |
| | fire- | type | 1-1 | 1-1 | 1-1 | 1-1 | 1-2 | 1-3 | 1-4 | 1-5 | — | A | A |
| | retardant | mixing ratio | 20 | 1 | 5 | 60 | 5 | 5 | 5 | 5 | — | 0.5 | 5 |
| | agent | (v/v %) | | | | | | | | | | | |
| EC | Initial | discharge capacity | 142.6 | 143.7 | 143.4 | 141.7 | 142.7 | 144.5 | 144.1 | 143.1 | 140.4 | 2 | 1 |
| | | (mAh/g) | | | | | | | | | | | |

| | | | | | | | | | | | | |
|---|---|---|---|---|---|---|---|---|---|---|---|---|
| LC | 0.1 C | 100 | 100 | 100 | 100 | 100 | 100 | 100 | 100 | 99 | — | — |
| | 0.3 C | 98 | 100 | 100 | 98 | 99 | 100 | 100 | 99 | 95 | — | — |
| | 0.5 C | 94 | 97 | 96 | 94 | 95 | 98 | 98 | 95 | 91 | — | — |
| | 1.0 C | 91 | 95 | 94 | 90 | 92 | 96 | 96 | 93 | 85 | — | — |
| | 3.0 C | 81 | 85 | 85 | 80 | 83 | 87 | 86 | 84 | 71 | — | — |

LC = load characteristic

TABLE 4

| | | | example | | | | | | | | | |
|---|---|---|---|---|---|---|---|---|---|---|---|---|
| | | | 17 | 18 | 19 | 20 | 21 | 22 | 23 | 24 | 25 | 26 |
| NES | electrolyte | type | LiPF₆ | LiPF₆ | LiPF₆ | LiPF₆ | LiPF₆ | LiPF₆ | LiPF₆ | LiPF₆ | LiPF₆ | LiPF₆ |
| | salt | | | | | | | | | | | |
| | nonaqueous | type | EC/ | EC/ | EC/ | EC/ | EC/ | EC/ | EC/ | EC/ | EC/ | EC/ |
| | solvent | (volume ratio) | DEC | DEC | DEC | DEC | DEC | DEC | DEC | DEC | DEC | DEC |
| | | | (1/2) | (1/2) | (1/2) | (1/2) | (1/2) | (1/2) | (1/2) | (1/2) | (1/2) | (1/2) |
| | | mixing ratio | 79.9 | 98.9 | 94.9 | 40 | 94.9 | 94.9 | 94.9 | 94.9 | 94.9 | 94.9 |
| | | (v/v %) | | | | | | | | | | |
| | fire- | type | 1-1 | 1-1 | 1-1 | 1-1 | 1-1 | 1-1 | 1-2 | 1-3 | 1-4 | 1-5 |
| | retardant | mixing ratio | 20 | 1 | 5 | 59.9 | 5 | 5 | 5 | 5 | 5 | 5 |
| | agent | (v/v %) | | | | | | | | | | |
| | film- | type | 2-1 | 2-1 | 2-1 | 2-1 | 2-2 | 2-3 | 2-1 | 2-1 | 2-1 | 2-1 |
| | forming | mixing ratio | 0.1 | 0.1 | 0.1 | 0.1 | 0.1 | 0.1 | 0.1 | 0.1 | 0.1 | 0.1 |
| | agent | (v/v %) | | | | | | | | | | |
| EC | Initial | discharge capacity | 118.5 | 122.3 | 121.5 | 116.9 | 123.1 | 119.5 | 120.3 | 124.7 | 123.9 | 120.9 |
| (20° | | (mAh/g) | | | | | | | | | | |
| C.) | 100 cycle | discharge capacity | 113.8 | 119.9 | 119.1 | 111.1 | 120.6 | 114.7 | 116.7 | 123.5 | 122.7 | 117.3 |
| | | (mAh/g) | | | | | | | | | | |
| | | DCRR (%) | 96 | 98 | 98 | 95 | 98 | 96 | 97 | 99 | 99 | 97 |
| | 500 cycle | discharge capacity | 105.5 | 112.5 | 110.6 | 104.0 | 113.3 | 106.4 | 108.3 | 116.0 | 115.2 | 110.0 |
| | | (mAh/g) | | | | | | | | | | |
| | | DCRR (%) | 89 | 92 | 91 | 89 | 92 | 89 | 90 | 93 | 93 | 91 |
| EC | Initial | discharge capacity | 118.1 | 121.8 | 121.1 | 117.4 | 122.5 | 118.8 | 119.6 | 123.6 | 123.0 | 120.4 |
| (60° | | (mAh/g) | | | | | | | | | | |
| C.) | 100 cycle | discharge capacity | 106.3 | 112.1 | 110.2 | 103.3 | 112.7 | 106.9 | 107.6 | 116.2 | 114.4 | 109.6 |
| | | (mAh/g) | | | | | | | | | | |
| | | DCRR (%) | 90 | 92 | 91 | 88 | 92 | 90 | 90 | 94 | 93 | 91 |
| | 500 cycle | discharge capacity | 96.8 | 101.1 | 99.3 | 89.2 | 99.2 | 99.8 | 96.9 | 108.8 | 107.0 | 101.1 |
| | | (mAh/g) | | | | | | | | | | |
| | | DCRR (%) | 82 | 83 | 82 | 76 | 81 | 84 | 81 | 88 | 87 | 84 |

| | | | | | | | | | | |
|---|---|---|---|---|---|---|---|---|---|---|
| DT(° C.) | — | — | 271 | — | 271 | — | 267 | 269 | 273 | 276 |
| nail penetration test | NA | NA | NA | NA | NA | NA | NA | NA | NA | NA |

TABLE 5

| | | | comparative example | | | |
|---|---|---|---|---|---|---|
| | | | 7 | 8 | 9 | 10 |
| NES | electrolyte | type | LiPF₆ | LiPF₆ | LiPF₆ | LiPF₆ |
| | salt | | | | | |
| | nonaqueous | type | EC/ | EC/ | EC/ | EC/ |
| | solvent | (volume ratio) | DEC | DEC | DEC | EMC |
| | | | (1/2) | (1/2) | (1/2) | (1/1) |
| | | mixing ratio | 100 | 99.9 | 99.5 | 95 |
| | | (v/v %) | | | | |
| | fire- | type | — | — | A | A |
| | retardant | mixing ratio | — | — | 0.5 | 5 |
| | agent | (v/v %) | | | | |
| | film- | type | — | 2-1 | — | — |
| | forming | mixing ratio | — | 0.1 | — | — |
| | agent | (v/v %) | | | | |
| EC | initial | discharge capacity | 115.3 | 119.3 | 2 | 1 |
| (20° | | (mAh/g) | | | | |
| C.) | 100 cycle | discharge capacity | 106.1 | 113.3 | — | — |
| | | (mAh/g) | | | | |
| | | DCRR(%) | 92 | 95 | — | — |
| | 500 cycle | discharge capacity | 94.1 | 102.6 | — | — |
| | | (mAh/g) | | | | |
| | | DCRR(%) | 82 | 86 | — | — |
| EC | initial | discharge capacity | 112.6 | 119.7 | 1.4 | 0.8 |
| (60° | | (mAh/g) | | | | |
| C.) | 100 cycle | discharge capacity | 89.0 | 104.1 | — | — |
| | | (mAh/g) | | | | |
| | | DCRR(%) | 79 | 87 | — | — |
| | 500 cycle | discharge capacity | 68.0 | 89.8 | — | — |
| | | (mAh/g) | | | | |
| | | DCRR(%) | 61 | 75 | — | — |

| | | | | |
|---|---|---|---|---|
| DT(° C.) | 252 | 252 | 250 | 261 |
| nail penetration test | smoke/fire | smoke/fire | smoke/fire | smoke/fire |

TABLE 6

| | | | example | | | | | | | | | |
|---|---|---|---|---|---|---|---|---|---|---|---|---|
| | | | 27 | 28 | 29 | 30 | 31 | 32 | 33 | 34 | 35 | 36 |
| NES | electrolyte | type | LiPF₆ | LiPF₆ | LiPF₆ | LiPF₆ | LiPF₆ | LiPF₆ | LiPF₆ | LiPF₆ | LiPF₆ | LiPF₆ |
| | salt | | | | | | | | | | | |
| | nonaqueous | type | EC/ | EC/ | EC/ | EC/ | EC/ | EC/ | EC/ | EC/ | EC/ | EC/ |
| | solvent | (volume ratio) | DEC | DEC | DEC | DEC | DEC | DEC | DEC | DEC | DEC | DEC |
| | | | (1/2) | (1/2) | (1/2) | (1/2) | (1/2) | (1/2) | (1/2) | (1/2) | (1/2) | (1/2) |
| | | mixing ratio | 79.9 | 98.9 | 94.9 | 40 | 94.9 | 94.9 | 94.9 | 94.9 | 94.9 | 94.9 |
| | | (v/v %) | | | | | | | | | | |
| | fire- | type | 1-1 | 1-1 | 1-1 | 1-1 | 1-1 | 1-1 | 1-2 | 1-3 | 1-4 | 1-5 |
| | retardant | mixing ratio | 20 | 1 | 5 | 59.9 | 5 | 5 | 5 | 5 | 5 | 5 |
| | agent | (v/v %) | | | | | | | | | | |
| | film- | type | 2-1 | 2-1 | 2-1 | 2-1 | 2-2 | 2-3 | 2-1 | 2-1 | 2-1 | 2-1 |
| | forming | mixing ratio | 0.1 | 0.1 | 0.1 | 0.1 | 0.1 | 0.1 | 0.1 | 0.1 | 0.1 | 0.1 |
| | agent | (v/v %) | | | | | | | | | | |
| EC | Initial | discharge capacity | 143.4 | 144.6 | 144.5 | 142.8 | 144.7 | 143.8 | 143.9 | 145.0 | 144.8 | 144.2 |
| (20° | | (mAh/g) | | | | | | | | | | |
| C.) | 100 cycle | discharge capacity | 137.7 | 141.7 | 141.6 | 135.7 | 141.8 | 138.0 | 139.6 | 143.6 | 143.4 | 139.9 |
| | | (mAh/g) | | | | | | | | | | |
| | | DCRR (%) | 96 | 98 | 98 | 95 | 98 | 96 | 97 | 99 | 99 | 97 |
| | 500 cycle | discharge capacity | 126.2 | 133.0 | 131.5 | 124.2 | 133.1 | 128.0 | 129.5 | 134.9 | 134.7 | 131.2 |
| | | (mAh/g) | | | | | | | | | | |
| | | DCRR (%) | 88 | 92 | 91 | 87 | 92 | 89 | 90 | 93 | 93 | 91 |
| EC | Initial | discharge capacity | 140.6 | 143.0 | 142.6 | 140.0 | 143.1 | 141.0 | 141.6 | 143.8 | 143.5 | 142.1 |
| (60° | | (mAh/g) | | | | | | | | | | |
| C.) | 100 cycle | discharge capacity | 125.1 | 131.6 | 129.8 | 123.2 | 131.7 | 126.9 | 127.4 | 135.2 | 133.5 | 129.3 |
| | | (mAh/g) | | | | | | | | | | |
| | | DCRR (%) | 89 | 92 | 91 | 88 | 92 | 90 | 90 | 94 | 93 | 91 |
| | 500 cycle | discharge capacity | 106.9 | 120.1 | 116.9 | 103.6 | 111.6 | 115.6 | 113.3 | 126.5 | 124.8 | 115.1 |
| | | (mAh/g) | | | | | | | | | | |
| | | DCRR (%) | 76 | 84 | 82 | 74 | 78 | 82 | 80 | 88 | 87 | 81 |

| | | | | | | | | | | |
|---|---|---|---|---|---|---|---|---|---|---|
| DT(° C.) | — | — | 271 | — | 271 | — | 267 | 269 | 273 | 276 |
| nail penetration test | NA | NA | NA | NA | NA | NA | NA | NA | NA | NA |

TABLE 7

| | | | comparative example | | | |
|---|---|---|---|---|---|---|
| | | | 11 | 12 | 13 | 14 |
| NES | electrolyte | type | LiPF₆ | LiPF₆ | LiPF₆ | LiPF₆ |
| | salt | | | | | |
| | nonaqueous | type | EC/ | EC/ | EC/ | EC/ |
| | solvent | (volume ratio) | DEC | DEC | DEC | EMC |
| | | | (1/2) | (1/2) | (1/2) | (1/1) |
| | | mixing ratio | 100 | 99.9 | 99.5 | 95 |
| | | (v/v %) | | | | |
| | fire- | type | — | — | A | A |
| | retardant | mixing ratio | — | — | 0.5 | 5 |
| | agent | (v/v %) | | | | |
| | film- | type | — | 2-1 | — | — |
| | forming | mixing ratio | — | 0.1 | — | — |
| | agent | (v/v %) | | | | |
| EC | initial | discharge capacity | 140.4 | 143.7 | 2 | 1 |
| (20° | | (mAh/g) | | | | |
| C.) | 100 cycle | discharge capacity | 129.2 | 136.5 | — | — |
| | | (mAh/g) | | | | |
| | | DCRR (%) | 92 | 95 | — | — |
| | 500 cycle | discharge capacity | 115.1 | 122.1 | — | — |
| | | (mAh/g) | | | | |
| | | DCRR (%) | 82 | 85 | — | — |
| EC | initial | discharge capacity | 137.2 | 142 | 1.4 | 0.8 |
| (60° | | (mAh/g) | | | | |
| C.) | 100 cycle | discharge capacity | 107.0 | 122.12 | — | — |
| | | (mAh/g) | | | | |
| | | DCRR (%) | 78 | 86 | — | — |
| | 500 cycle | discharge capacity | 83.7 | 102.24 | — | — |
| | | (mAh/g) | | | | |
| | | DCRR (%) | 61 | 72 | — | — |

| | | | | |
|---|---|---|---|---|
| DT(° C.) | 252 | 252 | 250 | 261 |
| nail penetration test | smoke/fire | smoke/fire | smoke/fire | smoke/fire |

TABLE 8

| | | | example | | | | | | | | | | comparative example | | | |
|---|---|---|---|---|---|---|---|---|---|---|---|---|---|---|---|---|
| | | | 27 | 28 | 29 | 30 | 31 | 32 | 33 | 34 | 35 | 36 | 11 | 12 | 13 | 14 |
| NES | electrolyte | type | LiPF₆ | LiPF₆ | LiPF₆ | LiPF₆ | LiPF₆ | LiPF₆ | LiPF₆ | LiPF₆ | LiPF₆ | LiPF₆ | LiPF₆ | LiPF₆ | LiPF₆ | LiPF₆ |
| | salt | | | | | | | | | | | | | | | |
| | nonaqueous | type | EC/ | EC/ | EC/ | EC/ | EC/ | EC/ | EC/ | EC/ | EC/ | EC/ | EC/ | EC/ | EC/ | EC/ |
| | solvent | (volume | DEC | DEC | DEC | DEC | DEC | DEC | DEC | DEC | DEC | DEC | DEC | DEC | DEC | EMC |
| | | ratio) | (1/2) | (1/2) | (1/2) | (1/2) | (1/2) | (1/2) | (1/2) | (1/2) | (1/2) | (1/2) | (1/2) | (1/2) | (1/2) | (1/1) |
| | | mixing ratio | 79.9 | 98.9 | 94.9 | 40 | 94.9 | 94.9 | 94.9 | 94.9 | 94.9 | 94.9 | 100 | 99.9 | 99.5 | 95 |
| | | (v/v %) | | | | | | | | | | | | | | |
| | fire- | type | 1-1 | 1-1 | 1-1 | 1-1 | 1-1 | 1-1 | 1-2 | 1-3 | 1-4 | 1-5 | — | — | A | A |
| | retardant | mixing ratio | 20 | 1 | 5 | 59.9 | 5 | 5 | 5 | 5 | 5 | 5 | — | — | 0.5 | 5 |
| | agent | (v/v %) | | | | | | | | | | | | | | |
| | film- | type | 2-1 | 2-1 | 2-1 | 2-1 | 2-2 | 2-3 | 2-1 | 2-1 | 2-1 | 2-1 | — | 2-1 | — | — |
| | forming | mixing ratio | 0.1 | 0.1 | 0.1 | 0.1 | 0.1 | 0.1 | 0.1 | 0.1 | 0.1 | 0.1 | — | 0.1 | — | — |
| | agent | (v/v %) | | | | | | | | | | | | | | |
| EC | initial | discharge | 143.4 | 144.6 | 144.5 | 142.8 | 144.7 | 143.8 | 143.9 | 145.0 | 144.8 | 144.2 | 140.4 | 144.1 | 2 | 1 |
| | | capacity | | | | | | | | | | | | | | |
| | | (mAh/g) | | | | | | | | | | | | | | |

| | | | | | | | | | | | | | | | |
|---|---|---|---|---|---|---|---|---|---|---|---|---|---|---|---|
| LC | 0.1 C | 100 | 100 | 100 | 100 | 100 | 100 | 100 | 100 | 100 | 100 | 99 | 100 | — | — |
| | 0.3 C | 99 | 100 | 100 | 99 | 100 | 99 | 99 | 100 | 100 | 99 | 95 | 98 | — | — |
| | 0.5 C | 95 | 98 | 97 | 95 | 98 | 96 | 97 | 99 | 99 | 97 | 91 | 94 | — | — |
| | 1.0 C | 92 | 97 | 95 | 92 | 97 | 94 | 94 | 98 | 98 | 95 | 85 | 89 | — | — |
| | 3.0 C | 82 | 87 | 84 | 81 | 87 | 83 | 83 | 89 | 88 | 84 | 71 | 78 | — | — |

As shown in Tables 1 to 8, the commonly-used nonaqueous secondary cells (Comparative Examples 1, 4, 7, and 11) containing the usual organic solvent as the nonaqueous solvent but without containing a fire-retardant agent generated smoke and fire during the nail penetration test. The nonaqueous secondary cells (Comparative Examples 2, 3, 5, 6, 9, 10, 13, and 14) containing the fire-retardant agent in which R₁ is a hydrogen atom also generated smoke and fire during the nail penetration test. The nonaqueous secondary cells (Comparative Examples 8 and 12) containing the methylenebissulfonate derivative but without containing a fire-retardant agent also generated smoke and fire during the nail penetration test. On the other hand, the nonaqueous secondary cells (Examples 1 to 36) containing the nonaqueous solvent to which the fire-retardant agent of the present invention was added did not develop any abnormalities such as smoke and fire during the nail penetration test.

The nonaqueous secondary cells of Examples 17 to 36 containing the methylenebissulfonate derivative are superior in battery performance to the nonaqueous secondary cells of Comparative Examples 1, 4, 7, and 11 without containing a methylenebissulfonate derivative.

The nonaqueous secondary cells of Examples 9 to 16 and 27 to 36 are superior in load characteristics, 90% or more at 1.0 C, to the nonaqueous secondary cells of Comparative Examples 4, 11, and 12, less than 90%.

The nonaqueous secondary cells of Comparative Examples 2, 3, 5, 6, 9, 10, 13, and 14 containing the fire-retardant agent in which R₁ is a hydrogen atom were incapable of being charged because the compound was decomposed upon the initial charge. The reason for this was that in the case where the substituent R₁, which binds to a nitrogen atom in the cyclic nitrogen-containing compound, is a hydrogen atom, this hydrogen atom binding to the nitrogen atom could be deprotonated because of lithium ions (cation) in the electrolytic solution. The deprotonated cyclic nitrogen-containing compound of Comparative Examples 2, 3, 5, 6, 9, 10, 13, and 14 becomes an anion, resulting in the possibility of complex formation. Because of this complex, the inventors of the present invention conceive that it may become certainly possible for the lithium-ion secondary cells to be incapable of fulfilling its original function.

### (The Cyclic Nitrogen-Containing Compounds Used in Examples 1 to 36)

Among the cyclic nitrogen-containing compounds represented by the formulae (1-1) to (1-5) above used in Examples 1 to 36, the cyclic nitrogen-containing compounds represented by the formulae (1-1), (1-2) and (1-5) were commercially available products; and the cyclic nitrogen-containing compounds represented by the formulae (1-3) and (1-4) were obtained by carrying out the following synthetic scheme.

### Compound (1-3)

Firstly 84 g of sodium azide (1.3 mol) was suspended in 1 L of acetonitrile, secondly 73 g of silicon tetrachloride (0.4 mol) was added dropwise to the suspension, thirdly 49 g of 4-heptanone (0.4 mol) was added dropwise, then the mixture was allowed to react at room temperature for 74 hours. After completion of the reaction, a reaction solution was extracted using water and methylene chloride; and an organic layer was concentrated under reduced pressure and was then purified by silica gel column chromatography so as to obtain 53 g of the cyclic nitrogen-containing compound (1-3) (0.33 mol) in a yield of 82%.

¹H-NMR (CDCl₃): 0.95 ppm (t, 3H), 1.01 ppm (t, 3H), 1.85 ppm (m, 2H), 1.91 ppm (m, 2H), 2.78 ppm (t, 2H), 4.19 ppm (t, 2H).

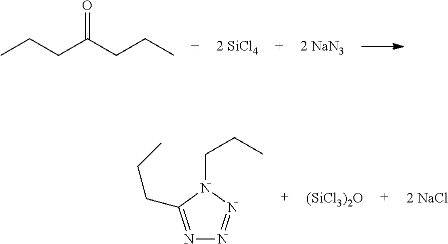

### Compound (1-4)

Firstly 84 g of sodium azide (1.3 mol) was suspended in 1 L of acetonitrile, secondly 73 g of silicon tetrachloride (0.4 mol) was added dropwise to the suspension, thirdly 52 g of acetophenone (0.4 mol) was added dropwise, then the mixture was allowed to react at room temperature for 74 hours. After completion of the reaction, a reaction solution was extracted using water and methylene chloride; and an organic layer was concentrated under reduced pressure and was then purified by silica gel column chromatography so as to obtain 38 g of the cyclic nitrogen-containing compound (1-4) (0.24 mol) in a yield of 60%.

¹H-NMR (CDCl₃): 2.62 ppm (s, 3H), 7.47 ppm (m, 2H), 7.60 (m, 3H).

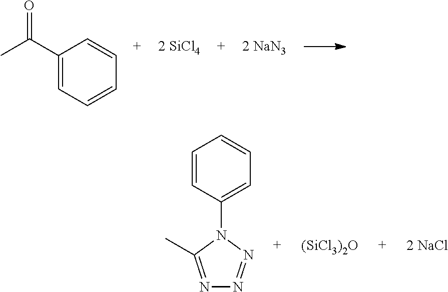

Note that the CAS number of the compound (1-1) is 90329-50-3, the CAS number of the compound (1-2) is 16681-77-9, the CAS number of the compound (1-4) is 14213-16-2, and the CAS number of the compound (1-5) is 18039-42-4.

### (Synthesis of the Methylenebissulfonate Derivatives Used in Examples 1 to 36)

### Compound (2-1)

In dimethyl carbonate (10 mL), 1.5 g of methylenebis(chlorosulphate) [ClSO₂OCH₂OSO₂Cl] (6.1 mmol) synthesized according to a method of U.S. Pat. No. 4,649,209 and 2.1 g of a methane sulfonic acid pyridinium salt (12.0 mmol) were reacted at 55° C. for 3 hours while being stirred. After completion of the reaction, a precipitated chlorosulfonic acid pyridinium salt was filtered off and a reaction solution concentrated under reduced pressure to obtain a light brownish-red solid. The solid was subjected to absorption treatment using activated carbon and was purified by recrystallization so as to obtain 0.6 g of a desired product, methylenebis(methanesulfonate) (2.9 mmol), in a yield of 48%.

¹H-NMR (CD₃CN): 5.80 ppm (s, 2H), 3.19 ppm (s, 6H).

### Compound (2-2)

0.6 g of methylenebis(ethanesulfonate) (2.5 mmol) in a yield of 41% was obtained in the same manner as the synthetic process of the compound (2-1) above, except that 2.3 g of an ethane sulfonic acid pyridinium salt (12.0 mmol) was used instead of the methane sulfonic acid pyridinium salt.

¹H-NMR (CDCl₃): 5.82 ppm (s, 2H), 3.31-3.26 ppm (q, 4H), 1.50-1.46 ppm (t, 6H).

### Compound (2-3)

0.7 g of methylenebis(allylsulfonate) (2.6 mmol) in a yield of 43% was obtained in the same manner as the synthetic process of the compound (2-1) above, except that 2.4 g of an allyl sulfonic acid pyridinium salt (12.0 mmol) was used instead of the methane sulfonic acid pyridinium salt.

¹H-NMR (CD₃CN): 5.93-5.82 ppm (m, 2H), 5.76 ppm (s, 2H), 5.55-5.49 ppm (m, 4H), 4.06-4.04 ppm (d, 4H).

### Compound (2-4)

1.2 g of methylenebis(benzenesulfonate) (3.5 mmol) in a yield of 58% was obtained in the same manner as the synthetic process of the compound (2-1) above, except that 2.8 g of a benzene sulfonic acid pyridinium salt (12.0 mmol) was used instead of the methane sulfonic acid pyridinium salt.

¹H-NMR (CD₃CN): 7.75-7.70 ppm (m, 6H), 7.58-7.53 ppm (m, 4H), 5.82 ppm (s, 2H).

What is claimed is:

1. A nonaqueous secondary cell comprising a positive electrode, a negative electrode, and a nonaqueous electrolytic solution, wherein the nonaqueous electrolytic solution contains at least a cyclic nitrogen-containing compound represented by the following general formula (1): 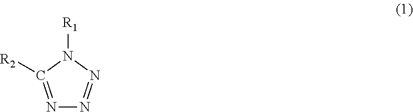
wherein R₁ is selected from a halogen atom, a lower alkyl group, a lower alkenyl group, a lower alkoxy group, a lower alkoxycarbonyl group, a lower alkylcarbonyl group and an aryl group, and R₂ is selected from a hydrogen atom, a halogen atom, a lower alkyl group, a lower alkenyl group, a lower alkoxy group, a lower alkoxycarbonyl group, a lower alkylcarbonyl group and an aryl group; or R₁ and R₂ are bonded together and are selected from a ring structure containing any of a methylene group, a vinylene group and a divalent linking group containing a hetero atom.

2. The nonaqueous secondary cell according to claim 1, wherein the nonaqueous electrolytic solution further contains a methylenebissulfonate derivative represented by the following general formula (2): 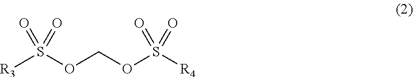
wherein R₃ and R₄ are each independently selected from a lower alkyl group, a lower alkenyl group, a lower alkynyl group, a lower alkoxy group, a lower aralkyl group, a heterocyclic group and an aryl group.

3. The nonaqueous secondary cell according to claim 1, wherein the R₂ is selected from a halogen atom, a lower alkyl group, a lower alkenyl group, a lower alkoxy group, a lower alkoxycarbonyl group, a lower alkylcarbonyl group and an aryl group; or is bonded with the R₁ and are selected from a ring structure containing any of a methylene group, a vinylene group and a divalent linking group containing a hetero atom.

4. The nonaqueous secondary cell according to claim 1, wherein, in the R₁ and R₂ of the cyclic nitrogen-containing compound represented by the general formula (1), the lower alkyl group is an alkyl group having 1 to 6 carbon atoms, the lower alkoxy group is an alkoxy group having 1 to 6 carbon atoms, and the lower alkenyl group is an alkenyl group having 2 to 6 carbon atoms.

5. The nonaqueous secondary cell according to claim 1, wherein the R₁ is an alkyl group having 1 to 6 carbon atoms or an aryl group, and the R₂ is a hydrogen atom or an alkyl group having 1 to 6 carbon atoms; or the R₁ and R₂ are bonded together and are a ring structure containing a methylene group.

6. The nonaqueous secondary cell according to claim 1, wherein the cyclic nitrogen-containing compound represented by the general formula (1) is contained from 1 to 60 vol % in the nonaqueous electrolytic solution.

7. The nonaqueous secondary cell according to claim 2, wherein, in the R₃ and R₄ of the general formula (2), the lower alkyl group is an alkyl group having 1 to 6 carbon atoms, the lower alkoxy group is an alkoxy group having 1 to 6 carbon atoms, the lower alkenyl group is an alkenyl group having 2 to 8 carbon atoms, the lower alkynyl group is an alkynyl group having 2 to 8 carbon atoms, the lower aralkyl group is an aralkyl group having 7 to 15 carbon atoms and the aryl group is an aryl group having 6 to 10 carbon atoms.

8. The nonaqueous secondary cell according to claim 2, wherein the R₃ and R₄ are each an alkyl group having 1 to 6 carbon atoms, an alkenyl group having 2 to 8 carbon atoms or an aryl group.

9. The nonaqueous secondary cell according to claim 2, wherein the methylenebissulfonate derivative represented by the general formula (2) is contained from 0.01 to 2 vol % in the nonaqueous electrolytic solution.

10. The nonaqueous secondary cell according to claim 1, wherein the nonaqueous electrolytic solution contains diethyl carbonate as an organic solvent.

11. A fire-retardant agent for nonaqueous secondary cell, comprising the cyclic nitrogen-containing compound represented by the general formula (1): 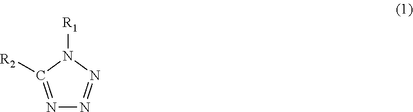
wherein R₁ is selected from a halogen atom, a lower alkyl group, a lower alkenyl group, a lower alkoxy group, a lower alkoxycarbonyl group, a lower alkylcarbonyl group and an aryl group, and R₂ is selected from a hydrogen atom, a halogen atom, a lower alkyl group, a lower alkenyl group, a lower alkoxy group, a lower alkoxycarbonyl group, a lower alkylcarbonyl group and an aryl group; or R₁ and R₂ are bonded together and are selected from a ring structure containing any of a methylene group, a vinylene group and a divalent linking group containing a hetero atom.

12. An additive for nonaqueous secondary cell comprising: the fire-retardant agent for nonaqueous secondary cell of claim 11; and a methylenebissulfonate derivative represented by the following general formula (2): 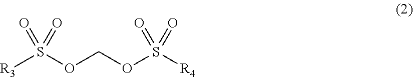
wherein R₃ and R₄ are each independently selected from a lower alkyl group, a lower alkenyl group, a lower alkynyl group, a lower alkoxy group, a lower aralkyl group, a heterocyclic group and an aryl group.
